(19) United States
(12) Patent Application Publication
(10) Pub. No.: US 2012/0018179 A1
(43) Pub. Date: Jan. 26, 2012

(54) FIRE SUPPRESION

(76) Inventor: Benjamin Adair Munro, North Shore City (NZ)

(21) Appl. No.: 13/144,930

(22) PCT Filed: Jan. 18, 2010
(86) PCT No.: PCT/NZ2010/000006

§ 371 Date: Jul. 17, 2011

(30) Foreign Application Priority Data
Jan. 16, 2009 (NZ) 574224

(51) Int. Cl. A62C 3/00

(52) U.S. Cl. 169/65

(57) ABSTRACT

The present invention relates to a fire suppression apparatus 220 and/or cooking appliance 222 with a fires suppression apparatus adapted for installation or installed at a location on or proximate the cooking appliance, the apparatus comprising one or more nozzles for coupling to a mains water supply 188 via one or more valves operable by a controller 190, wherein the controller 190 is triggerable by a fire sensor 240 to operate the one or more valves 190 to supply water to the nozzles 26 when a fire or activity indicative of a fire is sensed.

### FIELD OF THE INVENTION

The present invention relates to an apparatus for suppressing fire, and in particular, but not solely, fire in kitchens.

### BACKGROUND OF THE INVENTION

A typical fire suppressing system incorporates a sprinkler, or an array of sprinklers, that are positioned in the ceiling or above a cooking surface, for example in a range hood. A fire sensitive device is positioned somewhere in the room to detect the presence of a fire. When a fire is detected, the sprinkler system is enabled to attempt to suppress the fire.

### SUMMARY OF THE INVENTION

It is an object of the present invention to provide fire suppression that improves on existing systems, or at least provides the public with a useful choice.

In one aspect the present invention may be said to consist in a fire suppression apparatus adapted for installation at a location on or proximate a cooking appliance, the apparatus comprising one or more nozzles for coupling to a mains water supply via one or more valves operable by a controller, wherein the controller is triggerable by a fire sensor to operate the one or more valves to supply water to the nozzles when a fire or activity indicative of a fire is sensed.

In another aspect the present invention may be said to consist in a fire suppression apparatus installed at a location on or proximate a cooking appliance, the apparatus comprising one or more nozzles for coupling to a mains water supply via one or more valves operable by a controller, wherein the controller is triggerable by a fire sensor to operate the one or more valves to supply water to the nozzles when a fire or activity indicative of a fire is sensed.

Preferably the cooking appliance comprises a fire risk surface and location is lateral to the fire risk surface.

Preferably the cooking appliance comprises a fire risk surface and the fire risk surface comprises one or more fire risk regions, wherein the location is lateral to the fire risk region.

Preferably the location is nonadjacent to the fire risk region.

Preferably the fire risk region comprises one or more heating elements.

Preferably the location is such that the nozzles are disposed below, at or proximate the level of a fire risk region of the cooking appliance.

Preferably the nozzles are oriented to aim water laterally towards the fire risk surface and/or fire risk region.

Preferably the nozzles are oriented to aim water towards a region surrounding the fire risk surface and/or fire risk region.

Preferably only one fire apparatus installed and the location is a single location on or proximate the cooking appliance.

Preferably the fire sensor is a remote temperature sensor for determining a temperature above the fire risk surface and/or region and/or cooking appliance.

Preferably the apparatus further comprises a secondary sensor coupled to the controller for detecting a heated cooking utensil or other item that might cause the fire sensor to trigger the controller, wherein the secondary sensor detecting a heated cooking utensil or other item prevents the controller being triggered by the fire sensor.

Preferably the apparatus further comprises a secondary sensor coupled to the controller for detecting an obstacle that might prevent the fire sensor detecting a fire or activity indicative of a fire, wherein upon the secondary sensor detecting an obstacle remedial action is taken.

Preferably the location is in or on the cooking appliance, and the cooking appliance is plumbed for connection to or is connected to the mains water supply.

Alternatively the location is a bench top or other surface proximate the cooking appliance.

In another aspect the present invention may be said to consist in a fire suppression apparatus that is adapted for installation on a cooking appliance, wherein the cooking appliance is plumbed for coupling the fire suppression apparatus to the mains water supply.

In another aspect the present invention may be said to consist in a cooking appliance comprising: fire suppression apparatus, and plumbing for coupling the fire suppression apparatus to a mains water supply.

Preferably the cooking apparatus further comprises a fire risk surface wherein the fire suppression apparatus is installed on or proximate the fire risk surface and comprises one or more nozzles for coupling to the mains water supply through the plumbing via one or more valves operable by a controller, wherein the controller is triggerable by a fire sensor to operate the one or more valves to supply water to the nozzles when a fire or activity indicative of a fire is sensed.

Preferably the fire risk surface comprises one or more fire risk regions, wherein the fire suppression apparatus is installed lateral to the fire risk region.

Preferably the location is such that the nozzles are disposed below, at or proximate the level of a fire risk region of the cooking appliance

Preferably the location is nonadjacent to the fire risk region.

Preferably the fire risk region comprises one or more heating elements.

Preferably the nozzles are oriented to aim water laterally towards the fire risk surface and/or fire risk region.

Preferably the nozzles are oriented to aim water towards a region surrounding the fire risk surface and/or fire risk region.

Preferably the cooking appliance comprises only one fire apparatus installed and the location is a single location on or proximate the fire risk surface.

Preferably the fire sensor is a remote temperature sensor for determining a temperature above the fire risk surface and/or region.

Preferably the cooking appliance further comprises a secondary sensor coupled to the controller for detecting a heated cooking utensil that might cause the fire sensor to trigger the controller, wherein the secondary sensor detecting a heated cooking utensil prevents the controller being triggered by the fire sensor.

Preferably the cooking apparatus further comprises a secondary sensor coupled to the controller for detecting an obstacle that might prevent the fire sensor detecting a fire or activity indicative of a fire, wherein upon the secondary sensor detecting an obstacle remedial action is taken.

In another aspect the present invention may be said to consist in a fire suppression apparatus installed on or proximate a cook top or on a bench or other support surface proximate the cook top, wherein the apparatus comprises one or more nozzles for coupling to a mains water supply through plumbing in the cook top or bench or support surface via one or more valves operable by a controller, wherein the controller is triggerable by a fire sensor to operate the one or more valves to supply water to the nozzles when a fire or activity indicative of a fire is sensed, wherein the nozzles are directed at a fire risk region and/or regions on the cook top and/or surrounding areas.

Preferably the location is such that the fire suppression apparatus can emit supply water to a fire risk region unobstructed.

Preferably the location is outside a heat affected zone of a heating element and/or fire risk region.

The present description also describes following embodiments:

Optionally, the fire suppression apparatus is installed in a bench top or other area in the vicinity of the fire risk surface. Typically, the fire risk surface will be a cooking appliance.

Preferably, the nozzles are disposed to emit fire suppressant up or across the general area or vicinity proximate the general area of a likely resultant fire coming from the fire risk surface.

Preferably the cooking appliance comprises an oven and/or cook top.

Preferably the valves are operable by way of one or more controllers, wherein the controllers are triggered by the fire sensor.

Optionally, the controllers are integrally formed with the valves. Alternatively, the controllers are separate components. Optionally, the controllers can form part of the fire suppressing apparatus and/or plumbing, or can be located separately.

Optionally, the fire sensor can form part of the fire suppression apparatus. Alternatively, the fire sensor can be located separate.

Preferably the fire suppression apparatus is adapted for installation such that the nozzles are disposed at or proximate the level of a fire risk surface of the cooking appliance.

An aspect of the present invention described may be said to consist in a cooking appliance comprising: an oven and/or cook top, the oven and/or cook top presenting a fire risk surface when operational, fire suppression apparatus comprising one or more spray nozzles, and plumbing for coupling the one or more spray nozzles to a fire suppressant supply, wherein one or more operable valves control flow of fire suppressant through the plumbing to the one or more nozzles, the one or more valves being operable to allow flow of fire suppressant based on a fire sensor sensing a fire or activity indicative of a fire.

Preferably, the nozzles are disposed at or proximate the level of a fire risk surface of the cooking appliance.

Optionally the plumbing comprises the operable valves. Alternatively, the fire suppression apparatus comprises the operable valves. Alternatively, the cooking appliance comprises the operable valves.

Preferably the valves are operable by way of one or more controllers, wherein the controllers are triggered by the fire sensor to control the valves.

Optionally, the controllers are integrally formed with the valves. Alternatively, the controllers are separate components. Optionally, the controllers can form part of the fire suppressing apparatus and/or plumbing, or can be located separately.

Preferably, the fire sensor is disposed above a fire risk surface of the cooking appliance. Alternatively, the fire sensor is installed in the cooking appliance. Alternatively, the fire sensor is disposed in the fire suppression apparatus. Alternatively, the fire sensor is located separate from the cooking appliance and/or fire suppression apparatus.

Optionally, the fire suppression apparatus is adapted to communicate with a remote entity.

Optionally, the fire sensor is one or more of

heat detector,
thermocouple,
flame detector,
smoke detector.

An aspect of the present invention described may be said to consist in a fire suppression apparatus adapted for connection to a fire suppressant supply, the apparatus comprising: one or more spray nozzles, at least one valve operable into an open position to fluidly couple the one or more spray nozzles to a fire suppressant supply, wherein upon sensing a fire, the fire sensor is adapted to trigger a controller to operate the at least one valve into the open position.

Optionally, the fire suppression apparatus comprises the controller. Alternatively the controller is located separate from the fire suppression apparatus. The controller is connected or connectable to the fire sensor.

Optionally, the fire sensor is located remote to the fire suppression apparatus. Alternatively, the fire suppression apparatus comprises the fire sensor.

Preferably, the fire suppressant supply is a water supply for a faucet.

Preferably the fire suppressing apparatus has a spout to function as a faucet, and a first valve operable into an open position to fluidly couple the spout to a water supply for a faucet.

Preferably the fire suppressing apparatus is adapted to provide notification of status to a remote entity.

Optionally, the fire sensor is one or more of:

heat detector,
thermocouple,
flame detector,
smoke detector.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art

The term “comprising” as used in this specification means “consisting at least in part of”. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting

### BRIEF DESCRIPTION OF THE DRAWINGS

Preferred forms of the invention will now be described with reference to the accompanying drawings.

FIG. 1 is a kitchen plan with an example spray pattern from a fire suppressing apparatus.

FIG. 2 is a perspective view of a first embodiment of a fire suppressing apparatus.

FIG. 3 is a perspective view of the first embodiment showing internal features of the fire suppressing apparatus.

FIG. 4 is a schematic diagram showing further detail of the internal features of the fire suppressing apparatus.

FIG. 5 is a perspective view showing an alternative exterior of the fire suppressing apparatus.

FIG. 6 is a schematic diagram showing assembly of the fire suppressing apparatus.

FIG. 7 is a perspective view of a further alternative exterior of the fire suppressing apparatus.

FIG. 8 is a perspective view of a further alternative exterior of the fire suppressing apparatus.

FIG. 9 is a perspective view of a second embodiment of a fire suppressing apparatus

FIG. 10 perspective view of the fire suppressing apparatus according to the second embodiment showing internal features.

FIG. 11 is a cross sectional view of the fire suppression apparatus according to the second embodiment.

FIG. 12 is an illustration of the fire suppressing apparatus of the second embodiment.

FIG. 13 is cross sectional view of the fire suppressing apparatus according to a third embodiment.

FIG. 14 is a cross sectional view of the fire suppressing apparatus of FIG. 13 showing a different section angle.

FIG. 15 is a cross sectional view of the fire suppressing apparatus of FIGS. 13 and 14 showing a different section angle.

FIG. 16 is a cross sectional view of a further embodiment of the present invention.

FIG. 17 is an illustration of the fire suppression apparatus of the present invention incorporating a hydroelectric generator.

FIG. 18 is a perspective view of another embodiment of the invention with a fire suppression apparatus installed or installable in a cooking appliance.

FIGS. 19 to 21 show possible positions and details of a fire suppression apparatus.

FIG. 22 shows a perspective view of another embodiment of the invention with a fire suppression apparatus installed or installable remote from a cooking appliance.

FIGS. 23a, 23b show possible fire suppressant supplies.

FIG. 24 shows a possible positioning of a sensor.

FIG. 25 shows a schematic view of another possible embodiment that enables remote monitoring.

FIG. 26 shows a perspective view of another possible embodiment where a fire suppression apparatus is located remote and below a cooking appliance.

FIGS. 27a to 27f show possible positions and spray patterns of a fire suppression apparatus.

FIG. 28 shows a fire suppression apparatus with a secondary sensor.

### DETAILED DESCRIPTION OF THE PREFERRED EMBODIMENTS

This specification describes a fire suppressing apparatus (or fire suppressor) for installation in an area nearby a potential fire hazard or hazards. For example, the area may be a kitchen. A kitchen often hosts numerous cooking appliances that may cause a fire. Such cooking appliances comprise ovens, stove tops, toasters.

A fire suppressor is more commonly termed a “fire extinguisher”. These terms can generally be used interchangeably. It will be appreciated that due to various factors, a fire extinguisher may not always completely extinguish a fire. However, at least partially extinguishing or suppressing a fire does provide benefits in controlling a fire.

The term “faucet” in this specification is intended to refer to any type of tap or mixer used to control a water supply. The faucet may be a single water outlet, or mix several water supplies together, such as hot and cold water supplies.

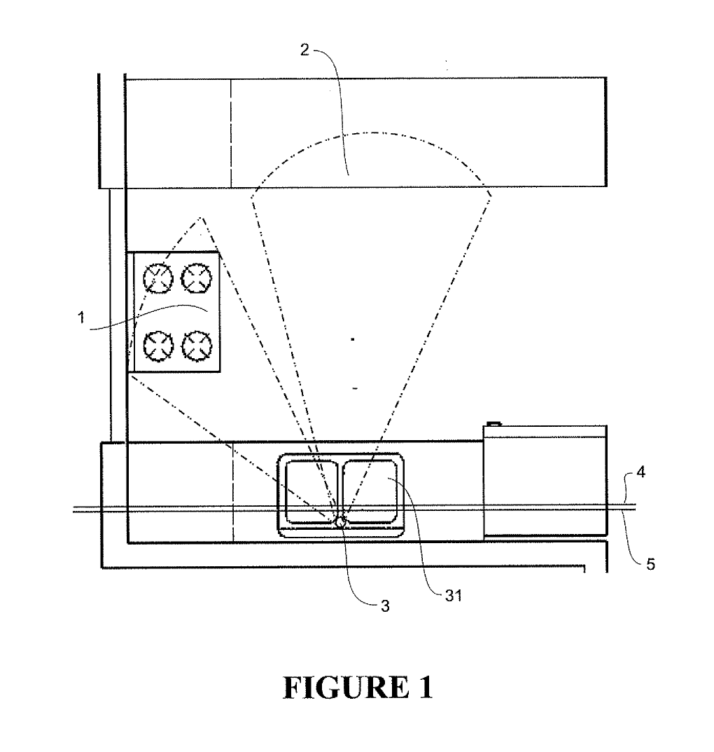

Referring to FIG. 1, a fire suppressing apparatus 3 according to the invention is placed proximate an existing water supply 4, 5. The water supply may exist to supply, for example, existing faucets and water consuming appliances. The apparatus 3 could be installed on or near a kitchen sink 31.

The fire suppressing apparatus (also termed “fire suppression apparatus”, “fire suppressor” or “fire suppression device”—these terms can be used interchangeably) of the invention comprises a plurality of outlets (spray nozzles). Each spray nozzle is preferably aimed at a potential fire hazard. FIG. 1 illustrates a pair of spray nozzles wherein one spray nozzle is aimed toward an oven or stove top 1, and another spray nozzle is aimed toward a bench top 2. The desired spray pattern of each spray nozzle can be customised for the particular area when the fire suppressing apparatus is installed.

It may also be advantageous to include a general sprayer designed to spray a mist of water across a local area to effectively douse all local surfaces in case of the fire spreading.

The fire suppressing apparatus 3 could comprise a spout and mixer device that connects to an existing hot and/or cold water supply thus replacing an existing faucet. The fire suppressing apparatus can connect to the mains or other water supply by any common plumbing connection, for example, by welding the pipes or a threaded interlocking connection. Alternatively, the fire suppressing apparatus is a unit without a spout and mixer placed in close proximity to an existing faucet, or at least in close proximity to an existing water supply.

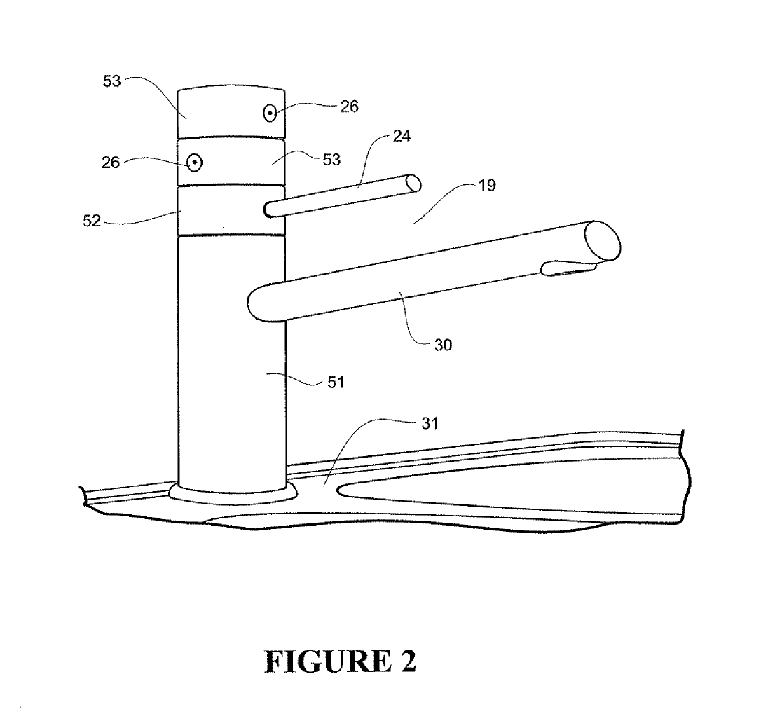

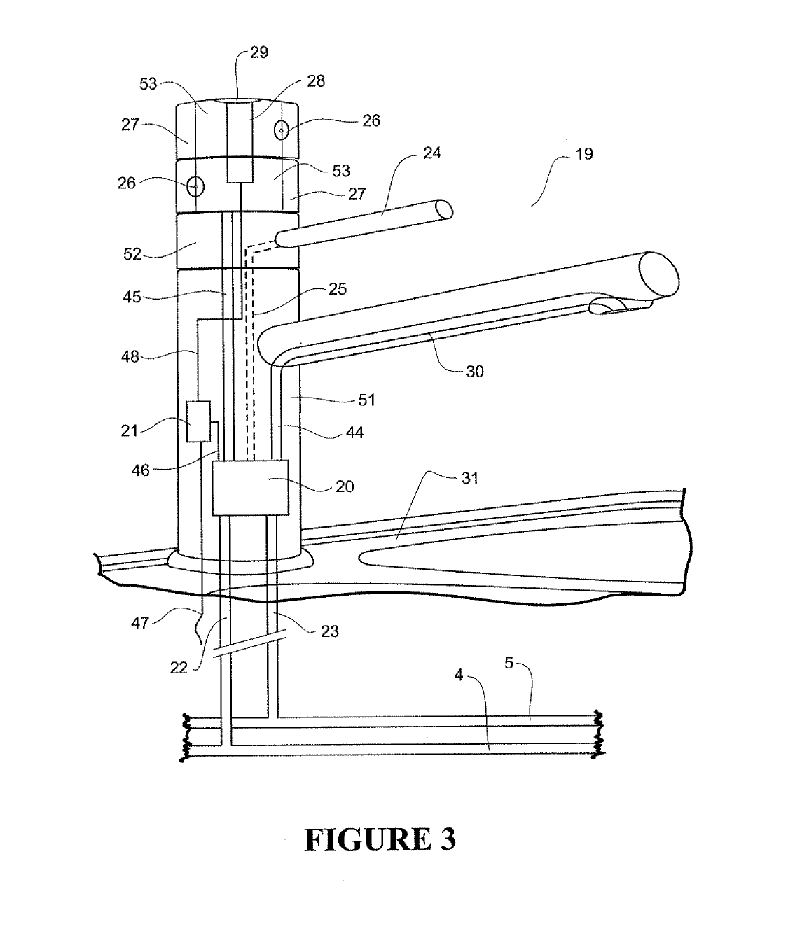

FIGS. 2 and 3 show a first embodiment of the invention whereby the fire suppression apparatus is formed from a number of spray nozzles in a device which also has a spout and a manually operated water control device. In this case the fire suppression apparatus resembles a faucet of a type commonly found in a kitchen. This could be the kind of faucet that is commonly installed on a kitchen sink or bench surfaces 31. Therefore, the fire suppression apparatus can function as a faucet as well as a fire suppressor. FIG. 3 shows a perspective view of the first embodiment illustrating in more detail internal components which form the fire suppression apparatus 19.

Referring to FIGS. 2 and 3 the first embodiment of the invention has a spout and a mixer whereby the fire suppression apparatus (comprising a number of spray nozzles) replaces an existing faucet. The fire suppression apparatus 19 comprises a main body 51 that is adapted to install on a kitchen sink or bench 31. A spout 30 extends from the main body 51 and a mixer handle 24 is connected to the main body 51. The mixer handle 24 can be swivelled and lifted by user to control the mixture and flow rate of hot and cold water through the spout 30. Two spray nozzles 26 are located above the handle. Each spray nozzle can be aimed in a desired direction, and with desired spray pattern and volume characteristics.

A mixing unit is disposed in the main body 51. The mixing unit 20 is preferably supplied by mains pressure or any other supply normally used to supply a faucet. For example, the mixing unit 20 is connected to a household hot and cold water supply 4, 5 through fluid channels 22, 23. The handle 24 is used to provide a user with control over the hot/cold mixture via internal linkage 25. Internal linkage 25 actuates the mixing valve mechanism within the mixing unit 20. The handle also allows the user to control fluid flow rate to the spout 30. Fluid channel 44 connects the mixing unit to the outlet of the spout.

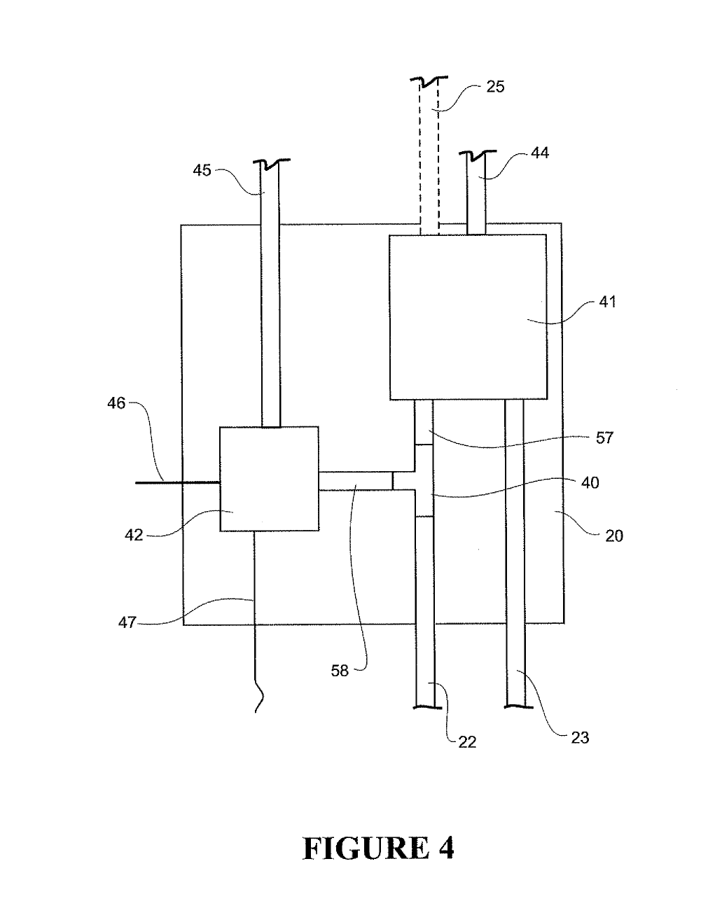

The fire suppressing apparatus also comprises a fire sensor 28 that can sense smoke, heat and/or fire, or another indicator of fire, and a controller unit 21 for operating a valve 42 (shown in FIG. 4). These allow for detection of a fire and control of water supply to the spray nozzles in response.

FIG. 4 illustrates an example of the internal components of the mixing unit 20. The hot and cold water channels 22, 23 are fluidly connected to the mixing unit 20. The cold water channel 22 is split into two fluid channels 57, 58 by a tee 40. The tee 40 is defined by any type of fluid diverging connection as known in the art.

Fluid channel 58 fluidly connects the mains pressure household cold water channel 22 to a valve 42. The valve 42 may be any type of fluid barrier controllable either directly or indirectly by an electrical signal. Preferably the valve 42 is operated by an electrical solenoid between an open and closed position. Pressurised water from supply channel 22 is fluidly connected to supply channel 45 when the valve 42 is in the open position. Pressurised water from supply channel 22 is fluidly disconnected from channel 45 when the valve 42 is in the closed position.

An electrical signal to operate the valve 42 is supplied through wire 46 from the controller 21. The simplest form of wire 46 is a single wire supplying a positive voltage, wherein an electrical ground connection is supplied through the body of the internal components. Alternatively wire 46 may comprise two wires that are isolated from other components in the fire suppressing apparatus.

Fluid channel 57 remains fluidly connected to a mixing unit 41 independent of operation of the valve 42. Similarly, fluid channel 58 remains fluidly connected to valve 42 independent of the operating of the mixing unit 41.

It can be appreciated that one, or some, or all of the tee 40, fluid channel 58, valve 42 and fluid channel 45 components can be located outside the mixing unit 20 without departing from their intended purpose.

As a further alternative, valve 42 may be plumbed directly to supply channel 22 and provide a first and second output. The first output is plumbed to the mixing unit 41, and a second output is plumbed to the spray nozzles 26.

Valve 42 would divert the water supply to the first output during normal faucet operation, and to the second output if a fire is detected.

Loss in water pressure to the spray nozzles is avoided by the mixer unit being isolated from the spray nozzles when a fire is detected and the faucet is on. This means that the fire suppressing apparatus works when the mixer/spout is operating.

Referring again to FIG. 3, the fire sensor 28 is located on an exterior surface of the fire sensing apparatus 19. Preferably the fire sensor unit is a remote or non-contact smoke, fire or heat sensor or similar. The fire sensor 28 is coupled to the controller 21 by a wire 48. An example of a remote heat sensor is an infrared temperature fire sensor 28, or infrared thermometer. An infrared thermometer has a output (e.g. voltage, current, signal or the like) that corresponds to the temperature in an aimed direction. Ideally the aimed direction is at the ceiling of a room directly, or at least approximately, above a potential fire hazard. Alternatively, the fire sensor might be a contact fire sensor such as a thermocouple or a flame detector or smoke detector, positioned so as to effectively measure evidence of a fire. Such a sensor is probably positioned at some distance from the rest of the apparatus, and communicates with the apparatus through a wire or through wireless radio or other communication. Alternatively, the fire sensor might be integrated into a cooking appliance such as a stove or range hold.

Alternatively, the aimed direction is at any ceiling space above the fire suppression apparatus where heat from a fire may rise to.

Alternatively the fire sensor could be located anywhere suitable that allows it to measure the heat of objects about the fire suppression apparatus, such as the ceiling. The location may be at, or near the top of the fire suppression apparatus.

It may be advantageous to provide a protective cover 29 above the sensor. Preferably the protective cover 29 transmits substantially all infrared radiation that is incident to it. Germanium or glass has proved an effective infrared transmitting material to construct a protective cover.

Controller unit 21 is supplied with electrical power via wire 47. The electrical power is preferably of low voltage and low current for safety in the presence of water. Preferably the electrical power is of sufficient voltage and current that the fire sensor 28, controller 21 and solenoid valve 42 may operate simultaneously without failure.

The controller unit 21 monitors the output of the fire sensor 28 via wire 48. The controller unit either alone or together with the fire sensor forms a fire detection unit. Preferably the output of the fire sensor 28 is representative of the ceiling temperature. The ceiling temperature will rise when there is a fire in the room before any other part of the room. Accordingly the controller unit 21 incorporates an upper predetermined temperature threshold that corresponds to the occurrence of a fire. The controller unit signals valve 42 to open via wire 46 when a temperature threshold is exceeded.

The opening of the valve 42 fluidly connects the pressurised mains water source 22 to the plurality of spray nozzles 26 via the fluid channel 45. The spray nozzles therefore spray water in a direction determined upon installation of the fire suppressing apparatus.

Preferably, the controller unit 21 incorporates a lower predetermined temperature threshold that corresponds to when a fire has been suppressed. Controller unit 21 closes valve 42 when the fire sensor 28 determines the ceiling temperature has dropped below the lower predetermined threshold. Accordingly, spraying will cease when the pressurised water supply is disconnected from the spray nozzles.

The upper ceiling temperature threshold required for the controller unit 21 to open the valve 42 has been found to work well when set to between 40°-400° degrees Celsius, although it is not essential for the threshold to be within this range—other ranges might be suitable. The lower temperature threshold required for the controller unit 21 to close the valve is when the temperature has returned to a safe value. It has been found to work well when set to a normal safe room temperature. Between 20°-50° degrees Celsius, has been found to be a useful range, although this is not essential. However, the upper and lower predetermined temperature thresholds may be equal, or different. The temperature thresholds may further be customised to a particular room requirement. For example, a large room may require a lower upper ceiling temperature threshold than a small room. It should be noted that while ceiling temperature is a preferable measure, this is not essential. Temperatures at other locations are possible.

The controller may not simply activate the valve at a set high temperature and deactivate the valve at a set low temperature. Optionally, the switching of the valve by the controller may consist of complex behaviour based on such sensor inputs as ambient temperature in the room, average temperature, time to heat to a set point in the event of a fire and minimum on times etc. These complex functions take into account various room sizes, ceiling heights, seasonal temperature fluctuations etc. but most importantly the characteristic time/temperature function indicating a fire.

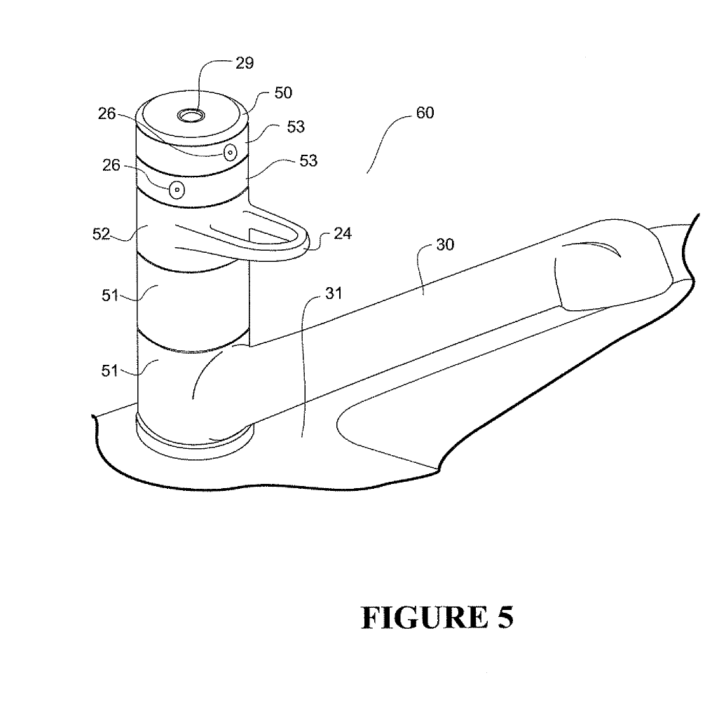

FIG. 5 provides an alternative exterior 60 to the fire suppression apparatus 19 of the first embodiment. This functions in the same manner.

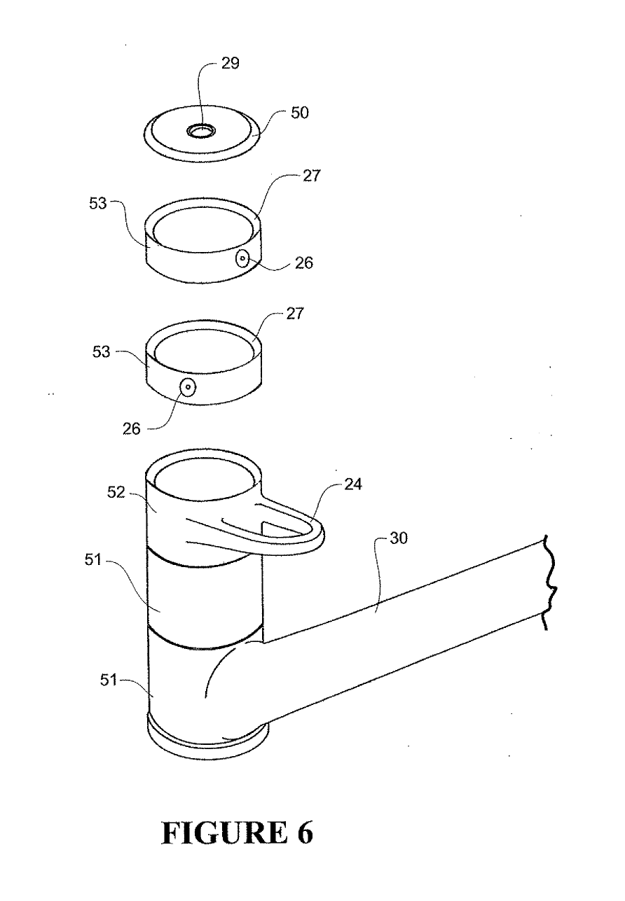

FIG. 6 provides an exploded view of the components of the fire suppression apparatus 19 in FIG. 5 that layer to construct the fire suppression apparatus 19 of the preferred embodiment. The fire suppression apparatus 19 has one or more base components 51 that are designed to mount to a surface. For example, the surface may be a kitchen bench. The base components 51 may also support the spout 30. Other components include a handle layer 52 that connects to the handle 24, one or more spray nozzle housing layers 53, and a cap 50.

Each of the spray nozzle housing layers 53 contains an internal fluid channel 27. Fluid channel 27 is designed to connect to fluid supply channel 45. Layering multiple spray nozzle housing layers fluidly connects the internal fluid channels between layers.

Cap 50 is designed to house or support the fire sensing device 28. Cap 50 is also designed to terminate fluid channel 27 when located above the uppermost spray nozzle housing layer 53.

Preferably each of the modular layers 50, 51, 52, 53 is interlocking and not separable or able to rotate when fastened together. Alternatively, it may be preferable to restrict only the spray nozzle housing layers from rotating, or changing their aimed direction when fastened together. In addition, the spray nozzle housing layers 53 may be freely rotated during installation to direct spray nozzles 26 in a desired direction, such as shown in FIG. 1.

Alternatively each of the spray nozzles may be plumbed directly to fluid supply channel 45, where the channel 45 is split as many ways as there are spray nozzles. The channel could be split by tee connections or similar.

Alternatively, each spray nozzle may be fluidly connected to the pressurised mains water supply source 22 via an independent valve. When the control unit senses a fire it selectively opens one or more of the valves.

Alternatively, each of the spray nozzles may be connected as a group that consists of one or more spray nozzles. Each group is connected to the pressurised mains water supply source 22 via an independent valve. When the control unit senses a fire it selectively opens one or more of the valves to fluidly connect one or more groups of spray nozzles.

Preferably the spray nozzle housing layers 53 are layered above the handle layer 52 and the one or more base layers 51. The protruding handle 24 and protruding spout 30 may intercept the spray pattern from the spray nozzles 26.

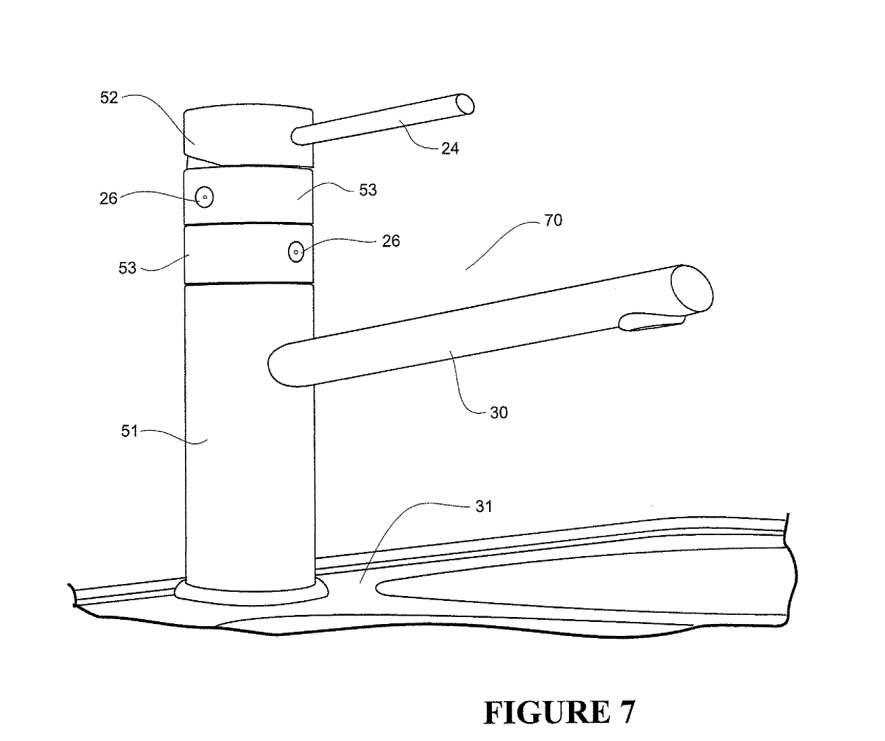

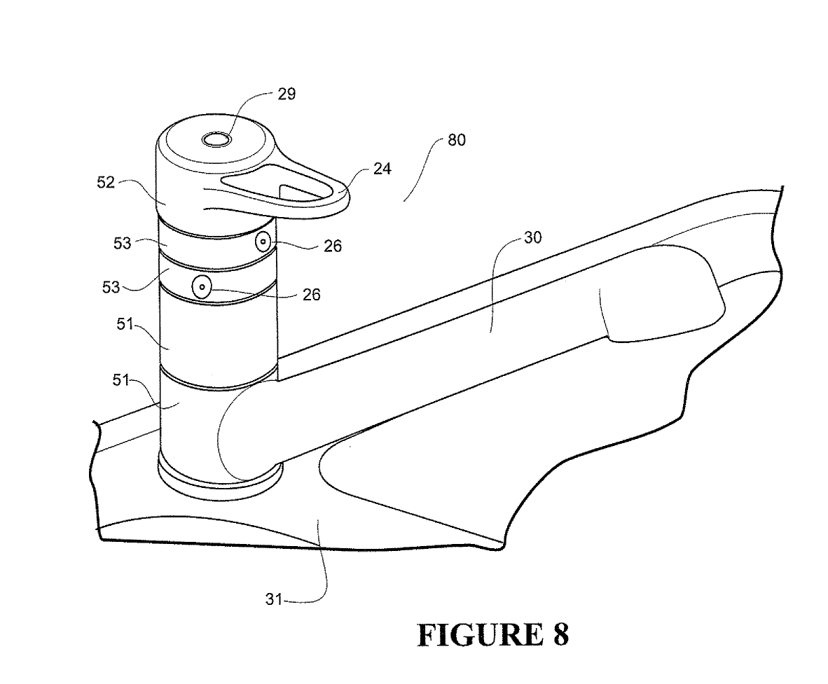

However, the spray nozzle housing layers may be placed below other layers if adequately spaced apart, or at least designed such the spray pattern is not intercepted. An interception of the spray pattern may cause detrimental performance to the fire suppressing intention of the apparatus. FIGS. 7 and 8 illustrate alternative exteriors 70, 80 and alternative layering of the interconnecting fire suppression apparatus components. Here, the spray nozzle housing layers 53 are located beneath the handle layer 52. It may be advantageous to locate the spray nozzles above the handle in certain situations where the handle 24 is large enough to intercept the spray pattern from the spray nozzle.

In another alternative, the fire suppression apparatus comprises a spout, without user operable valves and handles. In this case, the handles and valves (such as hot and cold water tap handles) are mounted proximate to the spout but separate.

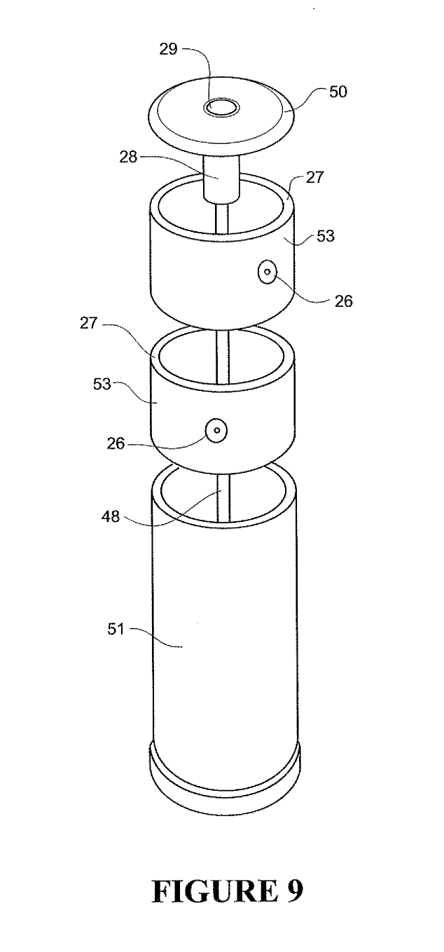

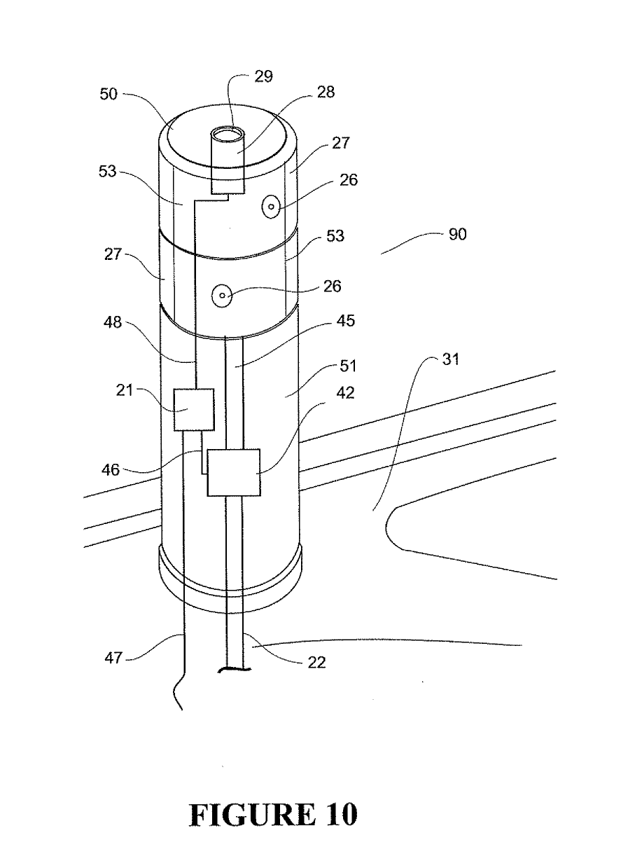

FIGS. 9 and 10 illustrate a view of a second embodiment of the fire suppression apparatus. FIG. 9 shows the apparatus in expanded fowl. The second embodiment is formed by layering a base unit 51, one or more spray nozzle housing layers 53 and a terminating cap 50. The fire suppression apparatus of the second embodiment is intended to be installed on a surface proximate an existing faucet, or at least proximate an existing water supply or proximate a water supply that has been modified to enable the installation of the apparatus. In this way the apparatus can be installed in an existing area containing potential fire hazards.

An advantage the apparatus of the second embodiment provides is the versatility to be positioned with clear line of sight to a potential fire hazard. The apparatus may also be installed by, for example, a home owner that does not want to change their existing faucet.

The spray nozzles 26 can be rotated such that they can be aimed in the direction of a potential fire hazard when the apparatus is installed. The apparatus may be installed on a bench top or kitchen sink top nearby an existing faucet or somewhere convenient in the kitchen.

The spray pattern of each of the spray nozzles can be customised to best suit the potential fire hazards in the area.

Each of the spray nozzle housing layers 53 contains an internal fluid channel 27. Fluid channel 27 is designed to connect to fluid supply channel 45. Layering multiple spray nozzle housing layers fluidly connects the internal fluid channels between layers.

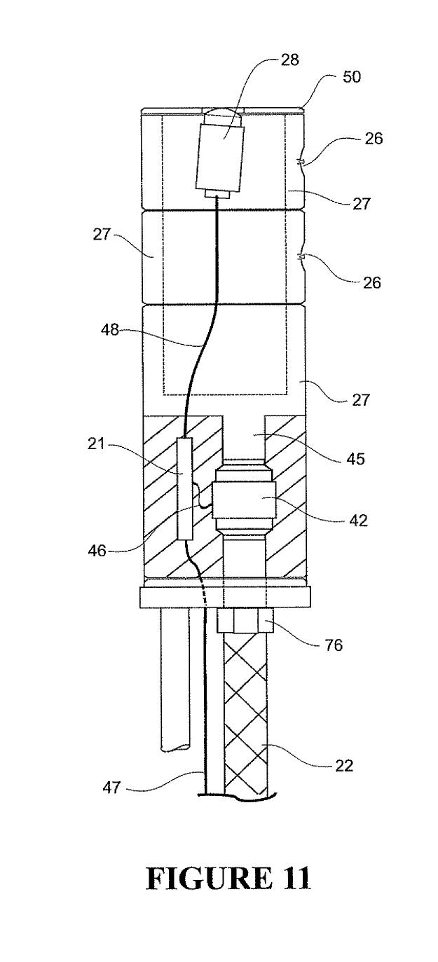

FIG. 11 shows an internal view of the second embodiment where the controller 21 and valve 42 axe housed internal to the fire suppression apparatus. The apparatus has a fluid channel 22 connected to the valve 42. Valve 42 is electrically opened and closed by a controller 21 via wire 46. A fire sensor 28 is electrically connected to the controller 46 via wire 48. Valve 42 is opened by controller 21 when a fire is sensed. Fluid channel 22 is fluidly connected to one or more spray nozzles 26 via internal fluid channel 27 when the valve 42 is opened.

Fluid channel 22 may be a length of pipe having an adaptation for connecting to an existing mains water supply. The adaptation may comprise a tee connection that separates the water supply into at least two paths as shown in FIG. 4. The fluid channel may also be connected to the base of the unit via a connection 76. The connection 76 may be a standard threaded connection as is commonly used in the plumbing industry, or it may be attached by other similar methods, such as welding or an interference fit.

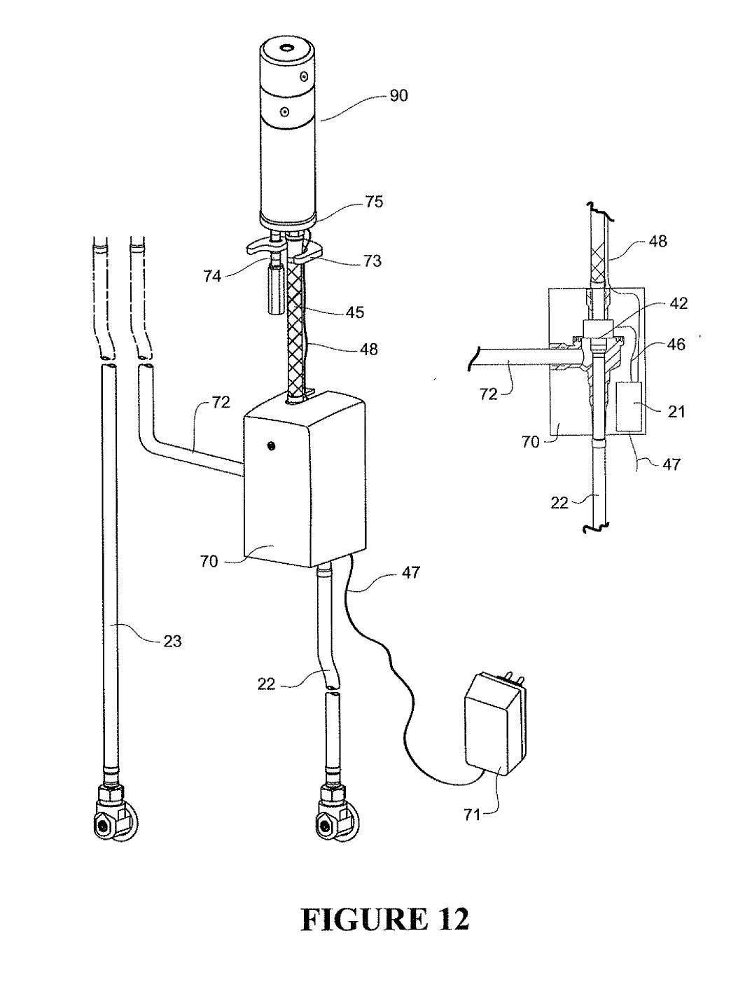

FIG. 12 is a diagram of the fire suppression apparatus according to the second embodiment having the controller 21 and valve 42 housed externally. The controller 21 and valve 42 are contained within an outer housing 70. The housing 70 can be attached to a convenient wall or inside surface of a cupboard or bench. The housing 70 protects the valve and controller structure from external interference. In addition, the housing 70 may physically support the components contained internally.

The controller 21 is supplied with power from an external wall adapter unit or mains connection 71 via wire 47. The controller 21 outputs electrical control signals to nearby valve 42 via wire 46, in response to electrical signals from the remote fire sensor via wire 48.

A cold water supply channel 22 is supplied to the housing 70. A hot water supply 23 is not connected to the apparatus. The water supply 22 is fluidly connected to the valve 42 inside the housing 70. Water channel 72 exits the housing 70 and may connect to existing nearby faucets or other water consuming devices. The water supply channel 22 is fluidly connected to water channel 72 during normal operation. When a fire is detected, the water channel 22 is fluidly connected to the spray nozzles and fluidly disconnected from channel 72.

A clamping surface 73 is attached to the lower end of the fire suppression apparatus via a threaded member 74. The threaded member 74 can be spun to raise and lower the height of the clamping surface 73 relative to the base of the apparatus 75. The apparatus can therefore be secured to a bench top via the clamping surface. For example, the apparatus 90 can be located above an aperture in the bench that allows the water channel 45 and electrical connection 45 to pass through. The threaded member 74 is rotated until the clamping surface 73 has been pressed into the lower surface of the bench top thus securing the apparatus.

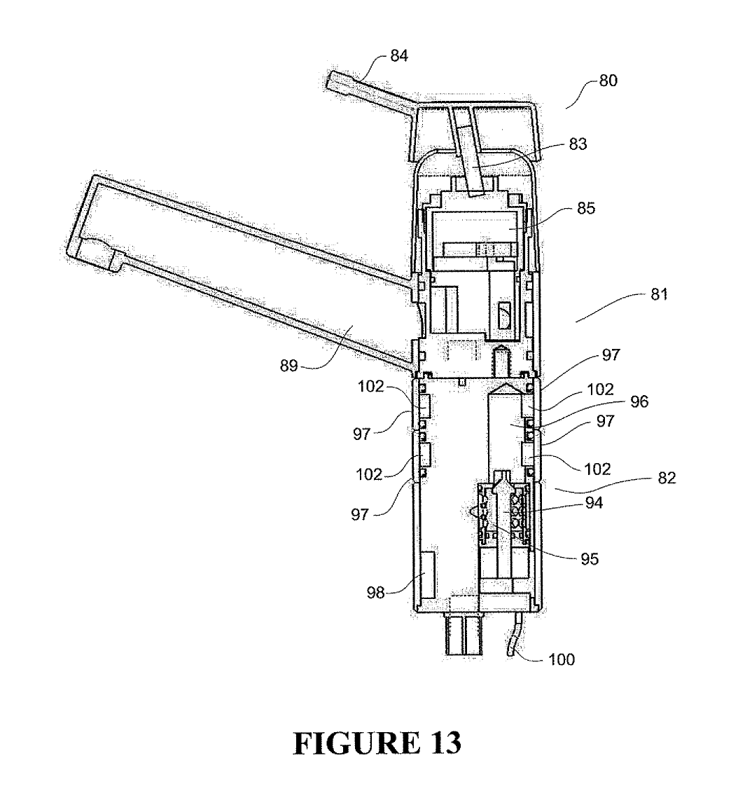

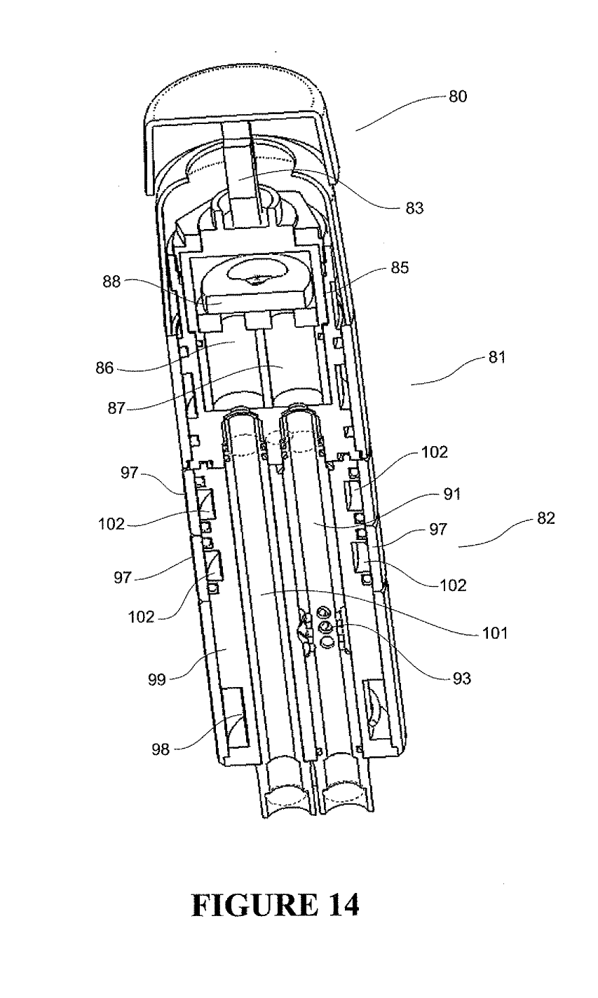

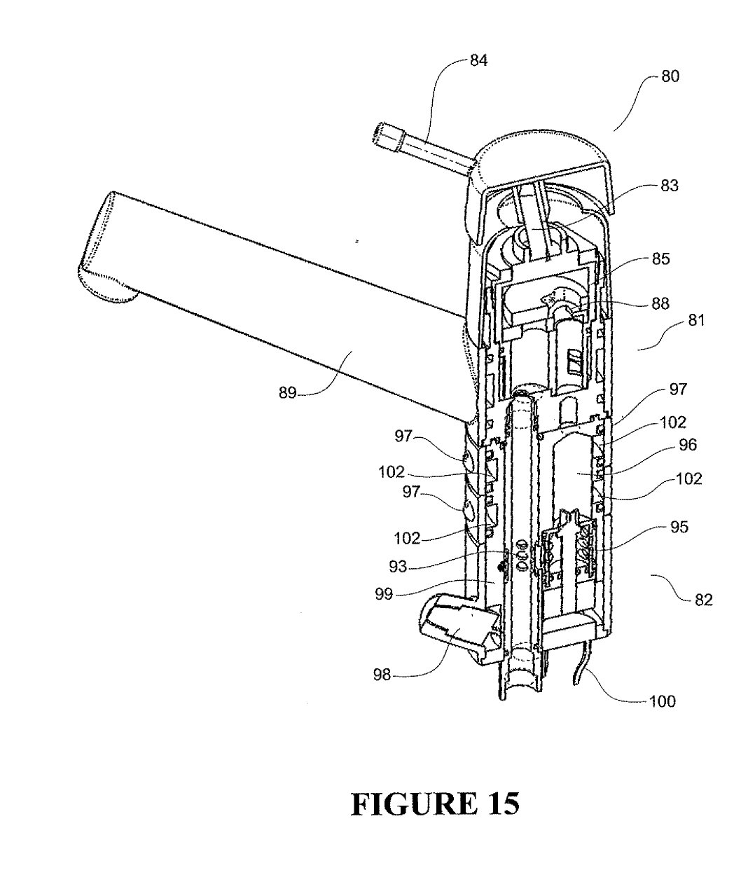

FIGS. 13, 14 and 15 show a cross sectional view of a third embodiment of the fire suppression apparatus of the present invention from various angles.

Referring generally to these three figures, the third embodiment consists of three main sections. These are the handle section 80 located at the top of the unit, the faucet section 81 located in the centre of the unit and the fire suppression section 82 located at the base of the unit.

The handle section 80 has a linkage 83 that connects the handle 84 to a mixer unit 85. The mixer unit 85 is a mixer cartridge of the type commonly used in the faucet industry. The mixer cartridge is typically a valve that receives a hot and cold water supply via input channels 86, 87. A ceramic plate 88 swivels to control the mix ratio of the hot and cold water supplies before channelling the mix to a spout 89. Those skilled in the art will know how this mixer cartridge operates.

The hot and cold water supply is fed via water channels 101, 91 respectively. The cold water supply channel 91 has an aperture, or apertures 93 for water to flow through into a valve 94. Preferably the valve 94 is an electromagnetic two way valve. Water remains in a lower chamber 95 when the valve 94 is closed or in a de-energised state. When the valve 94 is open, or in an energised state, water is allowed to flow through the apertures 93, the lower chamber 95 and into an upper chamber 96.

Preferably upper chamber 96 fluidly extends around the periphery of the lower section of the unit 82 to form an annular fluid channel 102. The upper chamber 96 is in fluid communication with a set of spray nozzles 97 via the annular fluid channel 102. When valve 94 is open, water from the water supply channel 91 is fluidly connected to spray nozzles 97. The fluid connection of the pressurised water supply to the spray nozzles 97 provides a stream of water that may be used to suppress a fire.

Located at the base of the fire suppression apparatus is a fire sensor 98. The fire sensor 98 can be aimed at the ceiling of a room above a potential fire hazard. The fire sensor is electrically connected to an embedded controller unit 99. The controller unit receives power via an electrical connection 100 and an input from the fire sensor 98. The controller 99 outputs a control signal to valve 94 when the fire sensor 98 detects the occurrence of a fire. The valve 94 subsequently opens to allow pressurised water to flow from water channel 91 through the apertures 93, through the lower chamber 95 into upper chamber 96 and therefore to the spray nozzles 97 via annular channel 102.

When the fire sensor 98 no longer detects the occurrence of a fire, or a predefined amount of time has elapsed, the controller 99 sends a control signal to close valve 94. The control signal to close valve 94 includes de-energising the electromagnetic coils in the valve 94 to allow it to close.

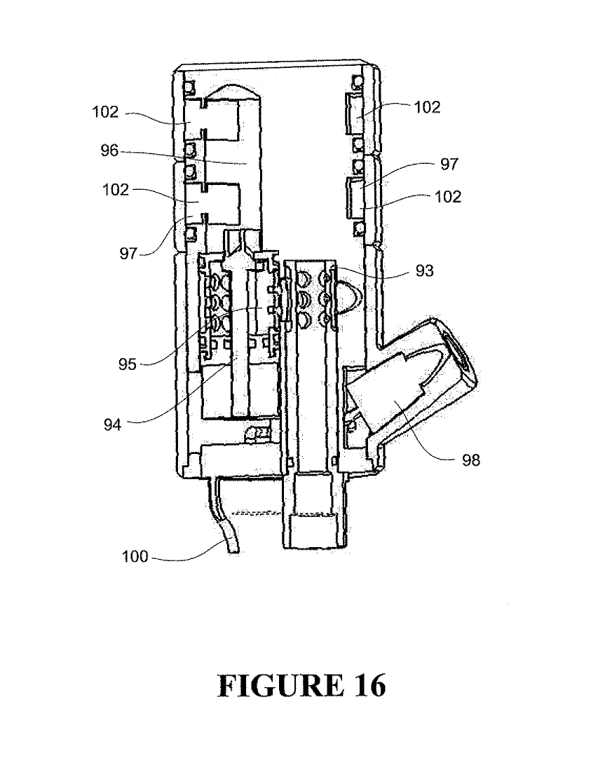

Another embodiment of the apparatus of the present invention is shown in FIG. 16. This functions in the same manner as the embodiment as shown and described in relation to FIGS. 13 to 15. However, this embodiment does not function as a faucet.

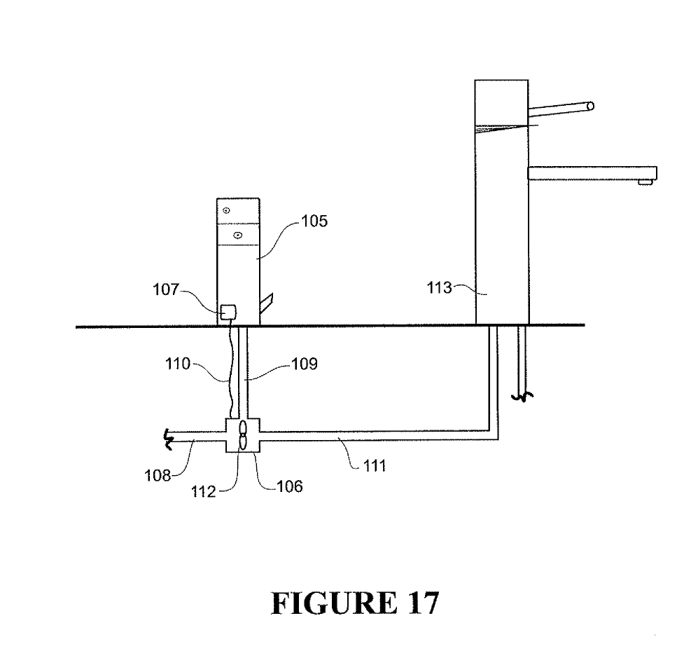

FIG. 17 shows one embodiment of fire suppression apparatus 105 connected to a hydroelectric generator 106. The generator 106 is located in a water supply channel that supplies the fire suppressing apparatus 105 and a nearby faucet 113. The generator has a propeller or turbine 112 that is spun by water flow to generate electricity.

The generator 106 could be located in the water channel 111 that supplies the nearby faucet or the main water supply channel 108. Alternatively the generator 106 could be located at the intersection of the main water supply channel 108, the supply channel 108 to the faucet 113 and the supply channel 109 to the fire suppression device 105.

Electrical power generated by the spinning propeller 112 is connected by wire 110 to the fire suppression device 105. Preferably the fire suppression device incorporates a rechargeable battery 107 connected to the supply of power from the generator. The rechargeable battery 107 is used to supply power to the other electrical components housed in the fire suppression device.

A solar or photovoltaic panel may be incorporated into the fire suppression device instead of the hydroelectric generator. Alternatively, the solar panel could work in parallel to the hydroelectric generator. Preferably the solar panel would be positioned in a sunlit location. The solar panel is connected to the rechargeable battery. The battery supplies electrical charge to the electrical components in the fire suppression device. Additionally, the solar panel recharges the battery.

The solar panel may also be used to directly power one or more of the electrical components in the fire suppression device when output power is sufficient to do so. Preferably the panel would be positioned in a location lit by the sun or artificial lighting or other sources of light.

FIG. 17 shows the fire suppression device as a standalone unit. The generator 106, battery and/or solar panel could be incorporated into a fire suppression device that is part of a faucet, such as described earlier. Further, a standard battery could be used in place of the rechargeable battery.

The first, second and third embodiment can be supplied as a complete unit, or a kit of parts for assembly into a complete unit.

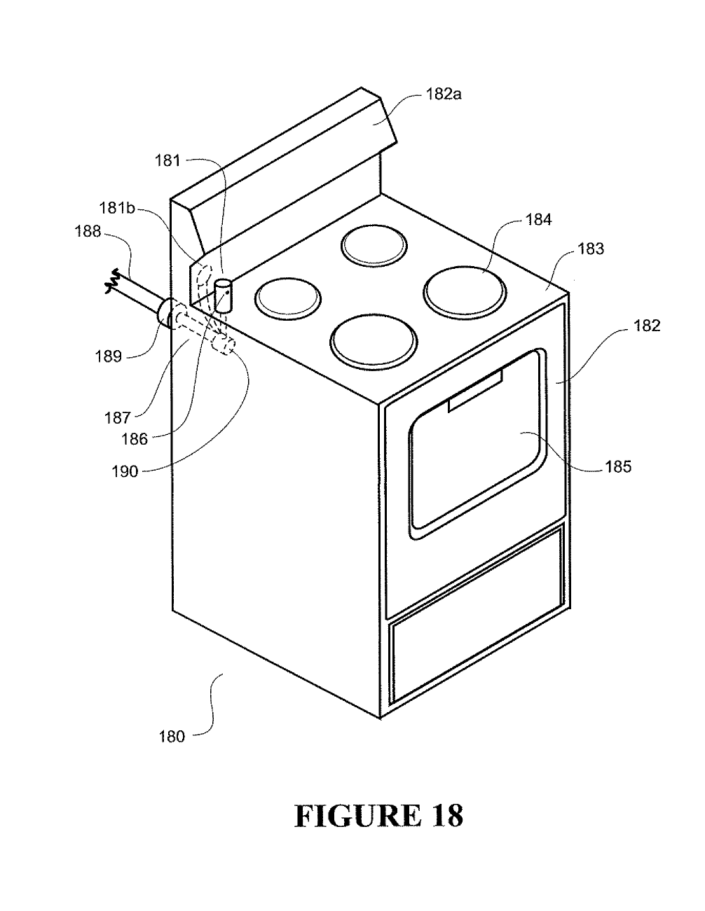

A further fire suppressor embodiment 180 is shown in FIG. 18. This comprises a fire suppression apparatus 181, such as any one of those described previously. The fire suppression apparatus is adapted for installation into a cooking appliance 182, or alternatively is installed in a cooking appliance 182. This embodiment can comprise the fire suppressing apparatus 181 alone or the combination of the fire suppressing apparatus 181 and cooking appliance 182. The adapted fire suppression apparatus could be provided separately for retro-fitting in an appropriate cooking appliance. Alternatively, it could be provided pre-installed in a cooking appliance for installation in a kitchen or other suitable location.

The cooking appliance 182 could be any appliance typically used in a kitchen or similar for the purposes of cooking. A cooking appliance might, for example, comprise an oven 185 alone, a cook top 183 alone or a combined oven and cook top (such as shown in FIG. 18). A cook top 183 comprises one or more elements, hot plates, hobs or similar 184 for providing heat for saucepans, frypans and the like. The cook top elements, hot plates, or hobs could be gas, induction heated, electric or similar. An oven 185 could be any suitable electric, gas or other oven. These are just some examples of a cooking appliance, and other cooking appliances could be envisaged. The cook top elements, hotplates or electric or gas hobs (hereinafter: “heating element”) 184 form or form part of fire risk regions in the cooking appliance. These are regions that pose a fire risk due to high heat and also the utensils and food that is near them. The fire risk regions can be the heating elements themselves, and/or the surrounding areas above, below and around the heating elements. Each heating element could be considered a fire risk region, resulting in multiple fire risk regions on a fire risk surface, or alternatively a group of heating elements can form a fire risk region. The cooking appliance 182 has one or more fire risk surfaces. These are surfaces/zones/regions of the cooking appliance on which the heating elements/fire risk regions are disposed and pose a risk of fire when operating. For example, the cook top 183 could be considered a fire risk surface, namely the surface supporting the heating elements. The fire risk surface can also comprise the area above, below and around the fire risk surface (e.g. area above, below and around the cook top). The entire fire risk surface could be a fire risk region.

The cooking appliance is adapted with plumbing 187 connected to (or connectable to) a fire suppressant supply 188 and to the fire suppression apparatus 181. The plumbing comprises one or more pipes or other conduits for transfer of fire suppressant from a connected fire suppressant supply 188 to the fire suppressing apparatus, and more particularly the outlets (nozzles) of the apparatus. The fire suppressant supply is mains water supply in a preferred embodiment. This allows water to be emitted from the nozzles towards a fire or fire risk region/surface, most preferably in the form of a mist. A mains water supply can be considered substantially non-exhaustible (e.g. relative to a tank). The mains will provide sufficient water pressure to produce a fine spray, and/or reach a wide enough area to properly douse the fire, fire risk region and surrounds. It will also provide sufficient volume to douse the fire, fire risk region, and surrounds without risk of the supply running low. The plumbing 187 also comprises couplings 189 or connectors for coupling the plumbing 187 to the fire suppressant supply 188 (e.g. mains water supply).

The fire suppression apparatus 181 is installed/installable by connecting it to the plumbing 187 and locating the apparatus 181 it at an appropriate point/location on the cooking appliance 182 to enable the nozzles 186 to douse fire suppressant on a possible fire. Preferably, the fire suppression apparatus is installed at a location on the cook top or other fire risk surface. Preferably, the nozzles 186 of the fire suppression apparatus 181 are disposed to be at or proximate the level of the fire risk surface, such as the cook top 183. Alternatively, as shown in dotted lines 181b, the fire suppression apparatus could be installed proximate the fire risk surface, such as on the back plate control panel 182a of the cooking appliance. It could be mounted within the internal portion of the control panel and connected to the plumbing 187 in a suitable manner. Other positions are possible also for the fire suppression apparatus.

Preferably, although it is not essential, the fire suppression apparatus is a single unit at a single location either on or proximate the cooking appliance, and most preferably on or proximate the fire risk surface. Using mains water supply allows a single fire suppression apparatus at a single location, as the pressure and substantially inexhaustible supply enables a large region to be sprayed with water, which allows suitable fire suppression without the need for nozzles in multiple locations. This also means the apparatus does not necessarily have to be directly adjacent to the fire risk regions/surface.

Following from this, the fire suppression apparatus can be installed at a location on or proximate the fire risk surface that is nonadjacent to the fire risk region(s). This removes the apparatus from danger areas (such as fire, heat, burning food, liquids, oil or the like) that might damage the apparatus and/or reduce its efficacy. Nonadjacent means anywhere not directly adjacent the fire risk regions (e.g. heating elements). Nonadjacent can mean sufficiently far away from a fire risk region to avoid dangers of fire, heat, burning foods, liquids, oils and the like. The fire suppression apparatus can be proximate the fire risk surface and/or region(s), yet still nonadjacent.

Preferably the fire suppression apparatus is installed at a location lateral to the fire risk surface and/or fire risk region(s). This allows fire suppressant (like water) to be emitted laterally towards the fire risk surface/region(s). This provides suppressant across the vertical/horizontal profile of the fire risk region(s), allowing flames, smoke, heat, cooking utensils, heating elements, fire risk surface, fire risk region(s), surrounding liquid/foods, and surrounding areas (e.g. walls, curtains, furniture) to be covered by the suppressant. A lateral discharge of suppressant also reduces the risk of spreading burning liquids.

Also provided are one or more valves that are operable to allow fire suppressant to pass through the plumbing 187 to the fire suppression apparatus 181, and ultimately the nozzles 186. The valves are preferably operable by one or more controllers that can be operated to open and close the valves to control the supply of fire suppressant through the plumbing.

The valves and controllers are, by way of example, generally shown schematically as box 190. This is for illustrative purposes only, and may not be the actual positioning of the valves/controllers. For example, the valves and controllers might be located internally or externally to the fire suppression apparatus, such as shown in FIG. 11 or 12.

In general, the valves can be provided in various different ways. For example, they can form part of the a) fire suppression apparatus, or b) plumbing, or c) cooking appliance or alternatively can be disposed in some other location. The actual location of the valves is not critical. The controller can be a micro-controller, micro-processor or similar. Similarly, in general the controller can form part of the a) plumbing, or b) valves (either integrally formed or attached), or c) fire suppression apparatus, or d) cooking appliance, or alternatively can be disposed in another location. The location of the controllers is not critical.

A fire sensor 240 is provided for detecting fire or activity indicative of fire, such as heat (temperature), smoke and/or flames. The fire sensor can be one or more of an infrared thermometer, thermocouple, heat detector, flame detector, smoke detector or the like. The sensor can be disposed in any suitable location, either in the fire suppressing apparatus 181 itself, or in or on the cooking appliance 182. Various locations for the fire sensor in the fire suppression apparatus have been described above. Preferably, the fire sensor is an infrared temperature sensor that can detect remote temperatures. More preferably, the fire sensor is an infrared temperature sensor directed to detect temperature about a fire risk region(s)/surface, such as the ceiling above such regions.

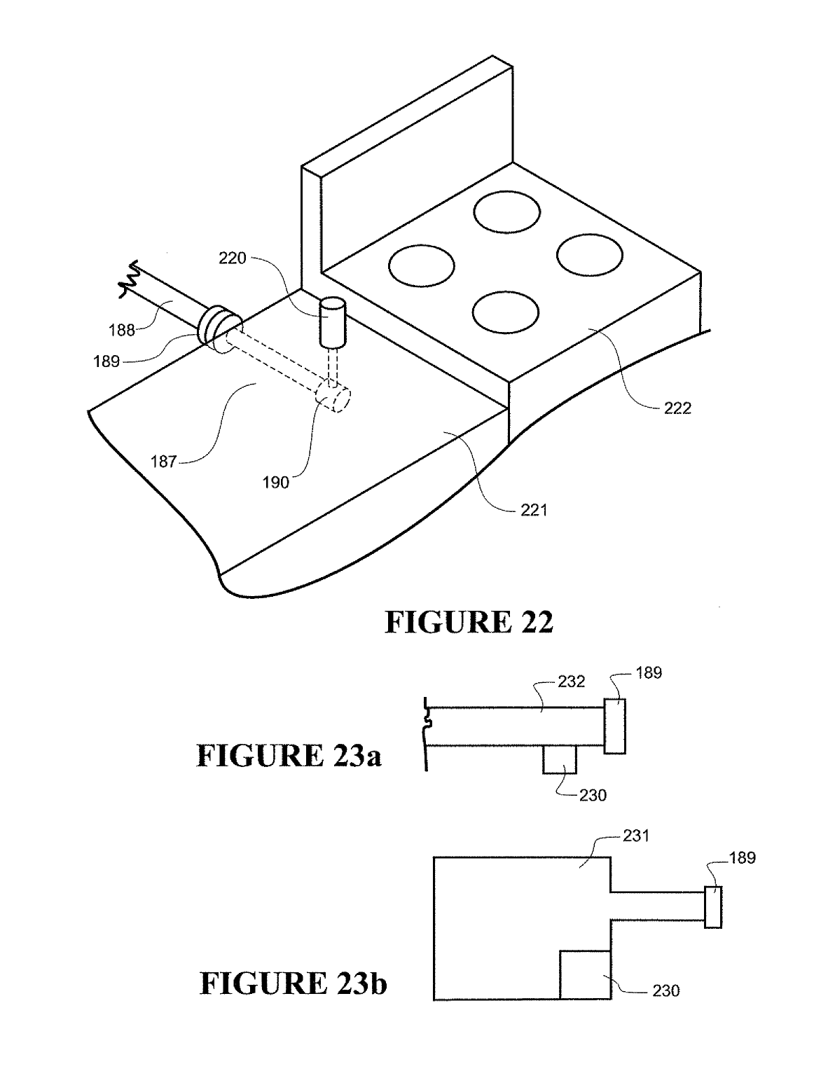

Alternatively, the fire sensor 240 can be installed remotely from the cooking appliance and/or fire suppressing apparatus at a location suitable for detecting fire or activity indicating fire on the fire risk surface. Referring to FIG. 24, preferably the fire sensor 240 is disposed above the fire risk surface/region(s), for example on a ceiling panel. When located remotely, the fire sensor will communicate with the fire suppressing apparatus (irrespective of its location) through a suitable communications link (typically a wireless link, e.g. RF, IR, sonic, although a wired link is possible). The fire sensor triggers the controllers to operate the valves to open and close to control the flow of fire suppressant to the nozzles of the fire suppression apparatus. FIG. 24 shows both the appliance mounted fire suppression apparatus, and also an alternative bench top mounted apparatus, which is described in more detail with respect to FIG. 22.

The fire sensor, depending on its type, can detect fire or activity indicative of fire in a number of ways. For example, it might try to detect activity indicative of fire (e.g. smoke, heat (temperature), flames or the like) on a ceiling or area above the likely source of fire (that is, the fire risk surface/region(s)). It might be directed towards detecting such activity in the likely fire area (fire risk region(s)/surface) itself. Other possibilities will be apparent to those skilled in the art. The nature of the fire sensor and the manner in which it detects fire is not limited to just those options described.

Installation of the combination cooking appliance/fire suppression apparatus would comprise connecting the appliance 182 to the gas and/or electricity supply as appropriate and in the usual manner. It would also comprise connecting the plumbing 187 in the cooking appliance to the fire suppressant supply 188 (most likely a mains water supply). The fire suppression apparatus 181 would be installed into the cooking appliance 182 at some suitable time (such as at time of manufacture), which would comprise connecting it to the plumbing 187. The fire suppression apparatus is also coupled to a suitable electricity supply for operation. This might be a battery, mains supply, hydroelectric, photovoltaic or any other suitable supply.

Once the combination fire suppressing apparatus and cooking appliance have been coupled to a suitable fire suppressant supply 188 (and also an electricity supply for the fire suppression apparatus where necessary) the assembly is then ready for use. Upon detecting fire or activity indicative of the fire, the fire sensor 240 will trigger the controller 190 to open the valves 190 in the plumbing. This will allow flow of the fire suppressant from the fire suppressant supply 188 to the nozzles of the fire suppression apparatus 181. The fire suppressant will then spray over the fire risk surface and/or fire risk region(s), thus suppressing any fire or impending fire. The fire suppression apparatus 181 provides a convenient way to reduce the risk of damaging fires by being conveniently located near the likely source of fire.

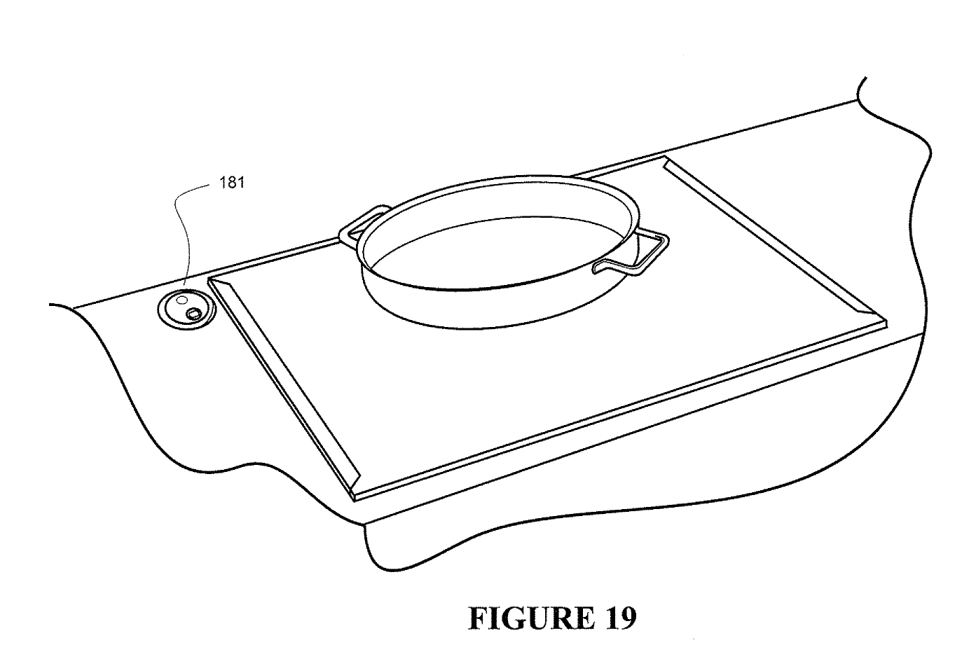

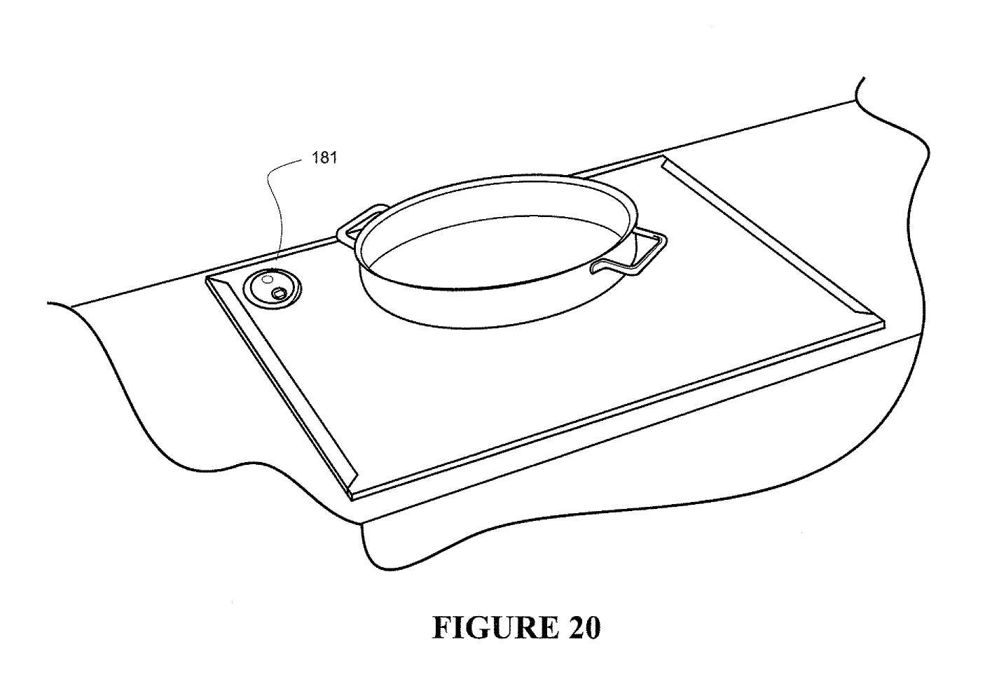

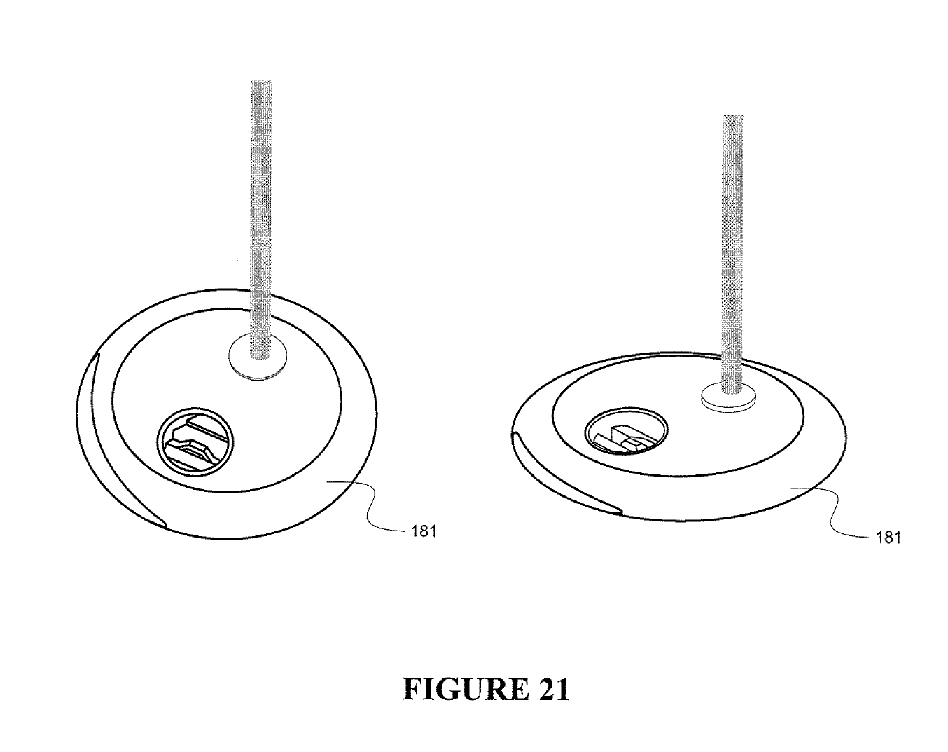

Optionally, the fire suppression apparatus 181 can be retracted and flush mounted within the cooking appliance for aesthetic appeal. A possible example for a bench-top mounted cook top is shown in FIGS. 19 to 21. In FIG. 19, the fire suppression apparatus 181 is installed adjacent the cook top. In FIG. 20, the fire suppression apparatus 181 is installed within the surface of the cook top. Further detail of one possible version of the retracted/flush mounted fire suppression apparatus is shown in FIG. 21. FIG. 21 shows the exposed portion of the fire suppression apparatus 181 when in the retracted position. The retracted fire suppression apparatus could be spring mounted such that when a fire is sensed, the apparatus 181 is triggered to release from its flush position to extend above the fire risk surface so that the nozzles are disposed in a suitable location to emit fire suppressant.

FIG. 22 shows an alternative embodiment. In this embodiment, the fire suppression apparatus 220 can be based on any embodiment previously described. Here, the fire suppressing apparatus is not installed in a cooking appliance 222 itself, but adapted to be installed (or is actually installed) proximate to the cooking appliance (and thus proximate the fire risk surface/region). In this case, it is installed in a bench top 221 that is adjacent a traditional cooking appliance 222. The bench top 221 comprises plumbing 187 like that described in relation to the embodiment of FIG. 18 to allow a fire suppressant supply 188 (most preferably mains water supply) to be connected to the fire suppression apparatus 220. The fire suppression apparatus 220 is installed such that the nozzles are disposed at or approximately level of the fire risk surface of the cooking appliance. In yet a further embodiment, the fire suppression device could be located some distance from the cooking appliance or other fire risk surface.

Again in this embodiment it is preferable, although it is not essential, that the fire suppression apparatus is a single unit at a single location either proximate or on the cooking appliance and most preferably on or proximate the fire risk surface. Using mains water supply allows a single fire suppression apparatus at a single location, as the pressure and substantially inexhaustible supply enables a large region to be sprayed with water, which allows suitable fire suppression without the need for nozzles in multiple locations. This also means the apparatus does not necessarily have to be directly adjacent to the fire risk regions/surface.

Following from this, in this embodiment, the fire suppression apparatus can be installed at a location proximate the fire risk surface that is nonadjacent to the fire risk region(s). This removes the apparatus from danger areas (such as fire, heat, burning food, liquids, oil or the like) that might damage the apparatus and/or reduce its efficacy. Nonadjacent means anywhere not directly adjacent the fire risk regions (e.g. heating elements). Nonadjacent can mean sufficiently far away from a fire risk region to avoid dangers of fire, heat, burning foods, liquids, oils and the like. The fire suppression apparatus can be proximate the fire risk surface and/or region(s), yet still nonadjacent.

Preferably in this embodiment the fire suppression apparatus is installed at a location lateral to the fire risk surface and/or fire risk region(s). This allows fire suppressant (like water) to be emitted laterally towards the fire risk surface/region(s). This provides suppressant across the vertical/horizontal profile of the fire risk region(s), allowing flames, smoke, heat, cooking utensils, heating elements, fire risk surface, fire risk region(s), surrounding liquid/foods, and surround areas (e.g. walls, curtains, furniture) to be covered by the suppressant. A significant proportion or the entire room/region of the fire could be doused, if appropriate. To assist this end, a pump 230 as described with reference to FIG. 23b might be used.

FIGS. 23a, 23b show possible fire suppressant supplies. Preferably, as shown in FIG. 23a, the fire suppressant supply 188 is a standard mains water supply 232, such as that provided for a faucet or other water usage device. The mains water supply 232 can be coupled to the plumbing 187 of the embodiments described in FIG. 18 or 22. Alternatively, the fire suppressant supply 188 can be provided from a tank 231, such as a header tank. Preferably, the tank will provide water as the fire suppressant, however other fire suppressants could be provided, such as foam. Another fire suppressant substance could be polyphosphate compound, for example. In either a tank 231 or a mains supply 232, optionally a pump 230 could be provided to increase the pressure and/or flow rate of the fire suppressant to the plumbing 187 and fire suppression apparatus.

Traditionally, the nozzles of fire suppression apparatus are placed above the level of the fire risk surface. For example, they are placed on the ceiling above the fire risk surface. This positioning is based on a general understanding that the fire suppressant should be sprayed from above the fire risk surface/fire risk region(s). The present inventor has determined that this is not necessary and suitable fire suppression can be achieved by delivering fire suppressant at the level of or proximate (e.g. just above, or just below) the level of the fire risk surface, preferably from a lateral and/or nonadjacent location. This could be a fire suppression device remote from the cooking appliance, or installed on a cooking appliance, as described above. In this manner, fire suppressant is sprayed at least partially laterally substantially across the fire. Also, it is not necessarily aimed at the base of the fire, but above the base of the fire into the general area of resultant heat, flames and/or smoke or into the vicinity proximate the resultant heat, flames and/or smoke.

Following from this, the inventor has determined that fire suppression can also be achieved by delivering fire suppressant from below the fire risk surface/region(s). It is not necessary for the suppressant to be directed towards the base of the fire. Rather, the fire suppressant can be sprayed upwards into the general area (or vicinity proximate the general area) of the resultant heat, flames and/or smoke.

When the suppressant is delivered from the below or at or just above the level of the fire risk surface it suitably douses the fire by cooling the fire, displacing oxygen to suppress the fire. Optionally, the suppressant is discharged as a (preferably lateral) “wall” of mist. This smothers the fire removing heat from it and the cooking utensil and heating element. It can also deposit fire suppressing material into the general area to retard fire spread. In the case where the fire suppressant is water, the water can vapourise when in the general area, thus suppressing the fire and also wetting the general area (beyond just the immediate fire risk surface/region(s)) to retard fire spread.

Delivering the fire suppressant from below, at, or just above the level of the fire provides significant advantages to existing overhead delivery methods. It means the fire suppression apparatus can utilise existing fire suppressant supply (such as mains water), thus simplifying installation and reducing cost. It avoids the need for installing complex plumbing and/or wiring and/or power to overhead positions.

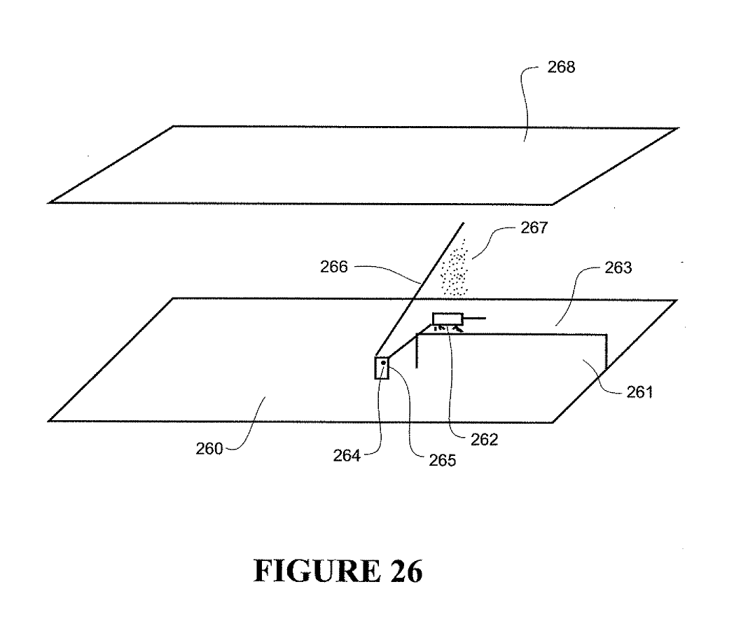

Following on from this, another embodiment of the present invention is described with respect to FIG. 26. This shows a general area 260 (such as a kitchen) that comprises a cooking appliance 261 (such as a gas stove top), with a hob 262 on a fire risk surface 263. A fire suppression apparatus 264 is installed in the general vicinity of the cooking appliance 261, below the level of the fire risk surface 263. The fire suppression apparatus 264 could be according to any previously described. If a fire occurs, it is likely to occur on the fire risk surface in the vicinity of the heating element 262. Resultant flames, smoke and/or heat will occur generally in the area 267 above the heating element 262. The nozzles 265 are arranged to emit fire suppressant 266 from below the fire risk surface 263 and upwards towards the general area 267 of a likely fire. The fire suppressant does not necessarily need to be directed at the likely location of the fire or base of the fire, but rather just the general area, which may be above the fire or base of the fire. It might even be aimed at the ceiling 268. The fire suppressant will cool a resulting fire, and displace oxygen, thus helping to suppress the fire. It can also distribute fire suppressant in the general area to reduce fire spread. Where the suppressant is water, it might vapourise, thus falling and suppressing the fire and wetting the general area. In this embodiment, the fire suppression apparatus 264 is still lateral to the fire risk surface and region(s), so is discharging suppressant at least partially laterally across the fire risk surface/region(s).

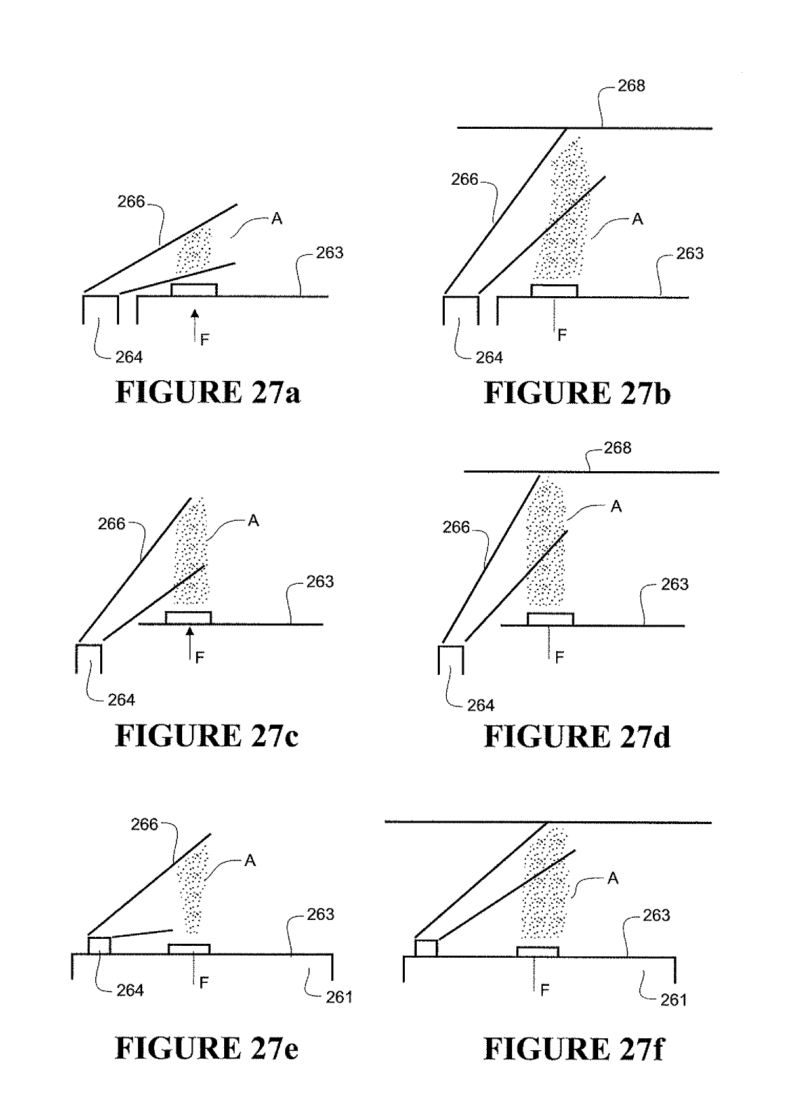

FIGS. 27a to 27f show alternative spray patterns for fire suppression apparatus. In each case there is a fire suppression apparatus 264, a fire risk surface 263, a heating element or other potential fire source F, and a general area A above the heating element were a fire is likely to occur (namely where the heat, smoke and/or flames would occur in case of fire). Some or all of these form the fire risk region.

FIG. 27a shows a fire suppression apparatus 264 at (or just above) the fire risk surface 263. Upon detection of a fire, the fire suppressant is sprayed laterally across the general area of the fire A, covering a horizontal/vertical profile of the fire risk region (and surrounding areas). Alternatively, as shown in FIG. 27b, the fire suppressant is sprayed upwards above the general area of fire from the fire suppression apparatus at (or just above) the fire risk surface 263. Optionally, it could be sprayed to a ceiling 268 or similar, where after the suppressant falls towards the general fire area A and suppresses the fire. Reference to a fire suppression apparatus 264 at or just above the fire risk surface could refer to one positioned remote (e.g. on a bench) from a cooking appliance, or one installed on a cooking device. FIGS. 27a, 27b show the option where the fire suppression apparatus is remote. FIGS. 27e, 27f show spray patterns as described above where the fire suppression apparatus is installed on a cooking appliance.

Alternatively as shown in FIG. 27c, the fire suppression apparatus 264 is located below the level of the fire risk surface 263. The fire suppressant in this case is sprayed upwards and above the heating element F into the general area A above the heating element F. In FIG. 27d, the fire suppression apparatus 264 is below the fire risk surface 263, and the suppressant is sprayed even higher above the fire area A. Optionally, it could be sprayed to a ceiling 268 or similar, where after the suppressant falls towards the general fire area A and suppresses the fire.

As can be seen in FIGS. 27a to 27f, each fire suppression apparatus is installed at a location lateral and nonadjacent to the heating element or other fire risk/heat producing region. Non adjacent means that the fire suppression apparatus is located outside the heat affected zone of the heating element/fire risk region during normal operation of the appliance. This reduces the effect of heat cycling on the fire suppression apparatus, and also means it is less likely to be affected by spilt/splattered food, flames, heat and other effects of cooking. This makes the suppression apparatus less prone to failure through heat or other stresses, or malfunction through being covered (e.g. by utensils or food) or functionality otherwise impaired through interference of cooking related matter and objects. Also, because it is clear of the heat affected zone, including the associated flames and/or heat, false positive triggering is less likely, as well as it can reduce the need for triggering thresholds or algorithms to compensate for the normal heat variations due to the heating element itself. This can make triggering easier and more reliable, and allow for triggering to take place at lower temperatures.

Nonadjacent also can mean that the fire suppression unit is far enough away from the heating element/fire risk region so that the suppressant (e.g. water) emitting from the nozzles are reasonably unobstructed (i.e. have “line of sight”) to the heating element/fire risk region. Any suppressant being emitted is less likely to be blocked by obstacles such as cooking utensils and/or heating elements themselves. In the case where the nozzles emit a mist, this might be formed as a “cone” (e.g. FIG. 27a). Nonadjacent can also mean sufficiently far away so that the cone is of sufficient size once it reaches the fire risk region to adequately douse the region, with reduced risk of being obstructed.

A fire suppression apparatus located lateral and nonadjacent to the fire risk regions/heating element improves the chances that the required area will be properly doused, without obstruction, filling the region and surrounds with water/mist that will remove heat from and/or smother the fire and/or surrounding utensils/apparatus/food and materials/obstacles.

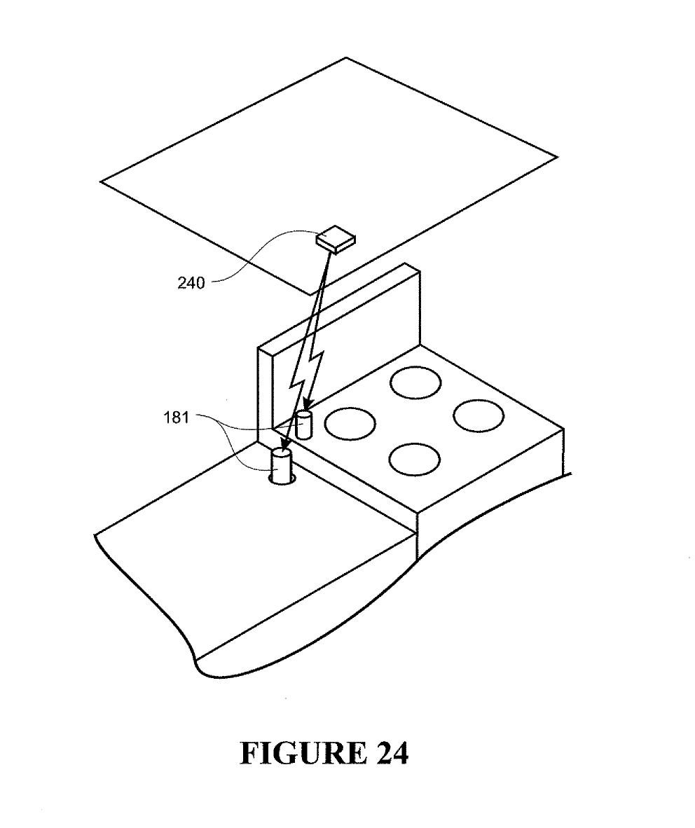

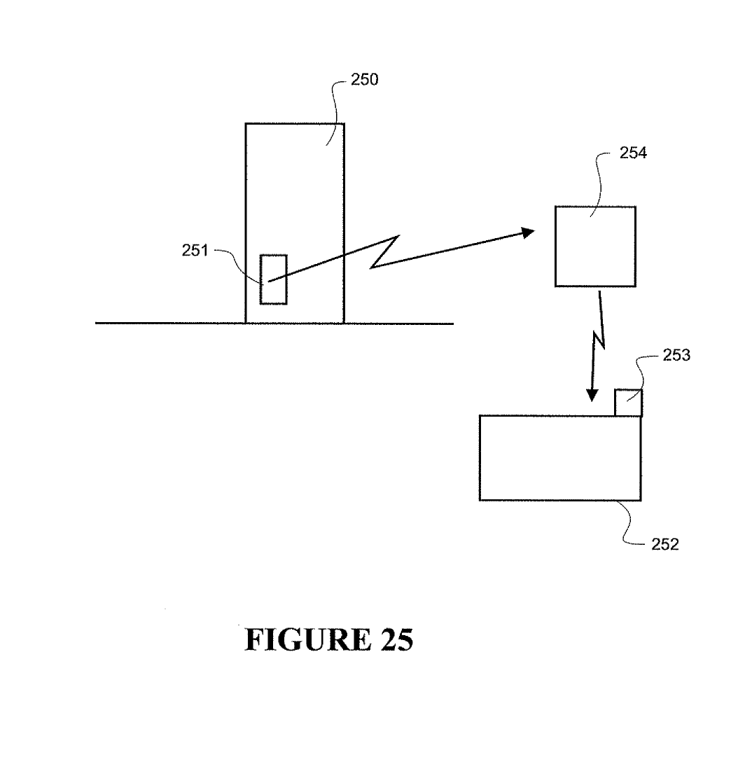

Another embodiment of the fire suppression apparatus 250 shown in FIG. 25. This fire suppression apparatus 250 could be based on any of those previously described and installed in any manner described previously. However, this embodiment has the additional capability of being in communication with a remote monitoring location 252. The fire suppression apparatus 250 can transmit its status and other data/information. For example, it has the capacity for an alarm notification service that provides for monitoring. Activation of the apparatus 250 triggers automatic communication with emergency services such as the fire service, or to any suitable telephone number, internet address or similar. It could also provide a communication or notification to an intermediary able to make those communications. Communication could alternatively take place continuously or periodically, independently of current operation status.

Preferably, the fire suppression apparatus 250 embodiment comprises a transceiving device 251, which is used as required. The transceiver 251 can then transmit and/or receive appropriate information indicating the status of the apparatus (such as active/non-active etc.), and/or any other useful information/data relating to the operation of the apparatus. Preferably the transceiver 251 provides the information wirelessly to the remote monitoring location 252 or to a suitable receiving device 253. The transmission could take place directly, or via a network 254 or other relay system. For example, the communications could be by way of mobile telephone network, internet communication, or the like. Alternatively, the transmission could take place via a wired service, such as a telephone line or wired network, for example.

The information/data, is transmitted over the transmission medium and then received at a receiving/transceiving device 253 at a remote location where the information/data can be used, interpreted and/or processed. The transceiving device 253 could be a mobile telephone, landline telephone, computer modem or the like.

Additionally, any of the embodiments described can be supplied with a contract for provision of ongoing service, which may include routine remote assessment of the alarm notification service or of the apparatus status (such as battery charge or other data). The remote assessment is by any means previously described such as landline telephone, mobile telephone or internet.

Any of the embodiments described could also have an alarm that sounds upon activation.

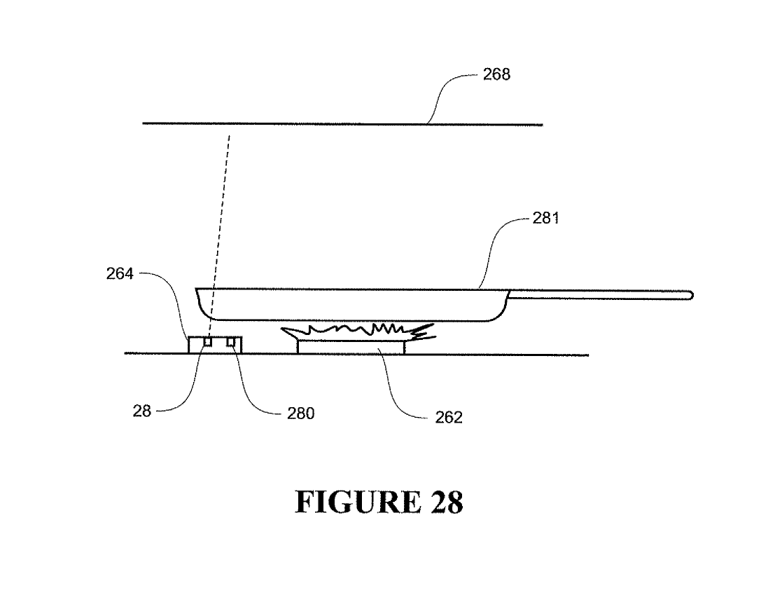

Referring to FIG. 28, a further embodiment of the invention comprises a secondary sensor 280 that can detect if an obstacle, e.g. a cooking utensil 281 or other item, is close to or covering the fire suppression apparatus 264 and/or fire sensor 28. It can do this using, for example, an infrared or proximity sensor. The secondary sensor 280 could be positioned adjacent the fire sensor 28 and/or on the top of the fire suppressing apparatus 264, although anywhere suitable will do. Such an embodiment can be the same as any previously described embodiment. If a cooking utensil 281 (or other item) covers the fire suppressing apparatus 264 and/or fire sensor 28, the secondary sensor 280 will trigger the controller to take remedial action, like sound and alarm and/or enter a failsafe mode.

If a cooking utensil 281 or other item covers the fire suppression apparatus 264 and/or fire sensor 28, two things could happen:
a) the fire sensor 28 might detect the heat of the cooking utensil 281 or other item, and trigger a false positive reading, thus activating the fire suppression apparatus 264 when there is no fire or danger of fire, and
b) prevent the fire sensor 28 detecting any fire or activity of fire.

These are both undesirable situations, and therefore the use of a secondary sensor 281 can reduce the risk.

1-33. (canceled)

34. A fire suppression apparatus adapted for installation at a location on or proximate a cooking appliance, the apparatus comprising one or more nozzles for coupling to a mains water supply via one or more valves operable by a controller, wherein the controller is triggerable by a fire sensor to operate the one or more valves to supply water to the nozzles when a fire or activity indicative of a fire is sensed.

35. A fire suppression apparatus according to claim 34 wherein the cooking appliance comprises a fire risk surface and the fire risk surface comprises one or more fire risk regions, wherein the location is lateral to the fire risk region.

36. A fire suppression apparatus according to claim 35 wherein the location is such that the nozzles are disposed below, at or proximate the level of a fire risk region of the cooking appliance

37. A fire suppression apparatus according to claim 35 wherein the nozzles are oriented to aim water laterally towards the fire risk surface and/or fire risk region.

38. A fire suppression apparatus according to claim 35 wherein the nozzles are oriented to aim water towards a region surrounding the fire risk surface and/or fire risk region.

39. A fire suppression apparatus according to claim 34 wherein the fire sensor is a remote temperature sensor for determining a temperature above the fire risk surface and/or region and/or cooking appliance.

40. A fire suppression apparatus according to claim 34 further comprising a secondary sensor coupled to the controller for detecting a heated cooking utensil or other item that might cause the fire sensor to trigger the controller, wherein the secondary sensor detecting a heated cooking utensil or other item prevents the controller being triggered by the fire sensor.

41. A fire suppression apparatus according to claim 34 further comprising a secondary sensor coupled to the controller for detecting an obstacle that might prevent the fire sensor detecting a fire or activity indicative of a fire, wherein upon the secondary sensor detecting an obstacle remedial action is taken.

42. A fire suppression apparatus according to claim 35 wherein the location is in or on the cooking appliance, and the cooking appliance is plumbed for connection to or is connected to the mains water supply.

43. A cooking appliance comprising: fire suppression apparatus, and plumbing for coupling the fire suppression apparatus to a mains water supply.

44. A cooking appliance according to claim 43 further comprising a fire risk surface wherein the fire suppression apparatus is installed on or proximate the fire risk surface and comprises one or more nozzles for coupling to the mains water supply through the plumbing via one or more valves operable by a controller, wherein the controller is triggerable by a fire sensor to operate the one or more valves to supply water to the nozzles when a fire or activity indicative of a fire is sensed.

45. A cooking appliance according to claim 43 wherein the fire risk surface comprises one or more fire risk regions, wherein the fire suppression apparatus is installed lateral to the fire risk region.

46. A cooking appliance according to claim 43 wherein the location is such that the nozzles are disposed below, at or proximate the level of a fire risk region of the cooking appliance

47. A cooking appliance according to claim 43 wherein the nozzles are oriented to aim water laterally towards the fire risk surface and/or fire risk region.

48. A cooking appliance according to claim 43 wherein the nozzles are oriented to aim water towards a region surrounding the fire risk surface and/or fire risk region.

49. A cooking appliance according to claim 43 comprising only one fire apparatus installed and the location is a single location on or proximate the fire risk surface.

50. A cooking appliance according claim 43 further wherein the fire sensor is a remote temperature sensor for determining a temperature above the fire risk surface and/or region.

51. A cooking appliance according to claim 43 further comprising a secondary sensor coupled to the controller for detecting a heated cooking utensil that might cause the fire sensor to trigger the controller, wherein the secondary sensor detecting a heated cooking utensil prevents the controller being triggered by the fire sensor.

52. A cooking appliance according to claim 43 further comprising a secondary sensor coupled to the controller for detecting an obstacle that might prevent the fire sensor detecting a fire or activity indicative of a fire, wherein upon the secondary sensor detecting an obstacle remedial action is taken.

53. A fire suppression apparatus installed on or proximate a cook top or on a bench or other support surface proximate the cook top, wherein the apparatus comprises one or more nozzles for coupling to a mains water supply through plumbing in the cook top or bench or support surface via one or more valves operable by a controller, wherein the controller is triggerable by a fire sensor to operate the one or more valves to supply water to the nozzles when a fire or activity indicative of a fire is sensed, wherein the nozzles are directed at a fire risk region and/or regions on the cook top and/or surrounding areas.
